(19) United States
(12) Patent Application Publication
(10) Pub. No.: US 2015/0279297 A1
(43) Pub. Date: Oct. 1, 2015

(54) DRIVE CAPACITY CONTROL FOR DISPLAY PANEL DRIVER AND DISPLAY DEVICE

(71) Applicant: Synaptics Display Devices KK, Tokyo (JP)

(72) Inventors: Tomotaka NAKANO, Kodaira (JP); Toshiyuki HIKICHI, Kodaira (JP); Norihiro ENOMOTO, Kodaira (JP)

(73) Assignee: SYNAPTICS DISPLAY DEVICES KK, Kodaira, Tokyo (JP)

(21) Appl. No.: 14/667,184

(22) Filed: Mar. 24, 2015

(30) Foreign Application Priority Data
Mar. 25, 2014 (JP) 2014061660

(51) Int. Cl. G09G 3/36; G06F 3/041

(52) U.S. Cl. CPC G09G 3/3622; G06F 3/041; G09G 3/3614; G09G 3/3696; G09G 2300/0426; G09G 2310/0289; G09G 2310/027

(57) ABSTRACT

A display device includes a display panel; and a driver. The display panel includes: first to third interconnections extended in a first direction, each having a first end connected to the driver; subpixels connected to the first interconnection and used for image display; and a bridge interconnection connecting the second and third interconnections at a second end of each of the second and third interconnections, the second end being located away from the driver. The driver includes: a first drive circuit driving the first interconnection; a second drive circuit driving the first end of the second interconnection; and a drive capacity control section receiving a first output signal from the first end of the third interconnection and controlling a drive capacity of the first drive circuit in response to a waveform of the first output signal.

### CROSS REFERENCE

This application claims priority of Japanese Patent Application No. 2014-061660, filed on Mar. 25, 2014, the disclosure which is incorporated herein by reference.

### TECHNICAL FIELD

The present invention relates to a display panel driver and a display device, and in particular, relates to adjustment of the drive capacity of a drive circuit for driving interconnections provided on a display panel.

### BACKGROUND ART

A source driver for driving source lines (also referred to as “signal lines” and “data lines”) of a display panel such as a liquid crystal display panel is required to write drive voltages into selected pixels within a specific time (e.g. within a display period in each horizontal synchronization period). The time duration allocated to write drive voltages into respective pixels is reduced for a high-resolution display panel, since drive voltages are written into a large number of pixels within a limited time period. In this case, it is necessary to increase the drive capacity of a drive circuit which writes drive voltages into the pixels (namely, a drive circuit which drives the source lines). On the other hand, the power consumption of the display device is unnecessarily increased when the drive capacity of the drive circuit is excessively large. An increase in the power consumption is not preferable especially for mobile devices, which require reduced power consumption. Additionally, an excessively large drive capacity of a drive circuit may cause an overshoot, and therefore an excessive drive capacity is not preferable also in this regard.

This discussion also applies to a gate driver which drives gate lines (also referred to as “scanning lines” and “digit lines”) of a display panel.

As thus discussed, it would be advantageous if the drive capacity of a drive circuit which drives interconnections provided on a display panel is appropriately adjusted. FIG. 1 illustrates the relationship among the drive capacity of a drive circuit, the drive waveform (the waveform of the voltage level on an interconnection to be driven), and power consumption. When the drive capacity of the drive circuit is small, the voltage level on the interconnection slowly varies in driving the interconnection but the power consumption is small. When the drive capacity of the drive circuit is large, on the other hand, the voltage level on the interconnection rapidly varies in driving the interconnection is driven but the power consumption is large. The drive capacity of the drive circuit is desired to be determined in consideration of desired drive waveform and power consumption.

One issue is that the appropriate drive capacity of a drive circuit may depend on each display panel due to process-induced variations. The delay characteristics of source lines and gate lines may depend on each display panel due to process-induced variations. This implies that the appropriate drive capacity of the drive circuit may be different depending on each display panel. Accordingly, even if the drive capacity of a drive circuit is set to a value considered as appropriate in designing, manufacturing, or inspection of the display panel driver, the drive capacity is not necessarily appropriate for the display panel actually mounted on a display device.

Japanese Patent Application Publication No. H11-242205 A discloses a technique for obtaining an optimum counter electrode drive signal by using a dummy signal line which is an extended gate signal line, a dummy source line, a dummy TFT (thin film transistor), and a Δv detection line.

### SUMMARY

The present invention provides a technique for appropriately adjusting the drive capacity of a drive circuit which drives an interconnection disposed on a display panel.

In one embodiment, a display device is provided that includes a display panel and a driver. The display panel includes first to third interconnections extended in a first direction, each having a first end connected to the driver, a plurality of first subpixels connected to the first interconnection and used for image display, a plurality of second subpixels connected to the second and third interconnections and not used for image display, and a bridge interconnection connecting the second and third interconnections at a second end of each of the second and third interconnections or in a vicinity of the second end of each of the second and third interconnections, the second end being located away from the driver. The driver includes a first drive circuit configured to drive the first interconnection, a second drive circuit configured to drive the first end of the second interconnection, and, a drive capacity control section configured to receive a first output signal from the first end of the third interconnection and control a drive capacity of the first drive circuit in response to a waveform of the first output signal.

In another embodiment, a display panel driver is provided for driving a display panel. The display panel driver includes first to third interconnections extended in a first direction, a plurality of first subpixels connected to the first interconnection and used for image display, a plurality of second subpixels connected to the second and third interconnections and not used for image display, and a bridge interconnection connecting the second and third interconnections at a first end of each of the second and third interconnections or in a vicinity of the first end of each of the second and third interconnections with the first end allocated away from the display panel driver. The display panel driver includes a first drive circuit configured to drive the first interconnection, a second drive circuit configured to input a step signal to a second end of the second interconnection, and a drive capacity control section configured to receive a first output signal from a third end of the third interconnection and configured to control a drive capacity of the first drive circuit in response to a waveform of the first output signal. The second end of the second interconnection being opposite to the first end across the second interconnection. The third end of the third interconnection being opposite to the first end across the third interconnection. Therefore, an advantage of the present invention is to provide a technique for appropriately adjusting the drive capacity of a drive circuit which drives an interconnection disposed on a display panel.

### BRIEF DESCRIPTION OF THE DRAWINGS

The above and other advantages and features of the present invention will be more apparent from the following description taken in conjunction with the accompanied drawings, in which:

FIG. 1 is a table illustrating the relationship among the drive capacity of a drive circuit, the drive waveform (the waveform of the voltage level on an interconnection to be driven), and the power consumption;

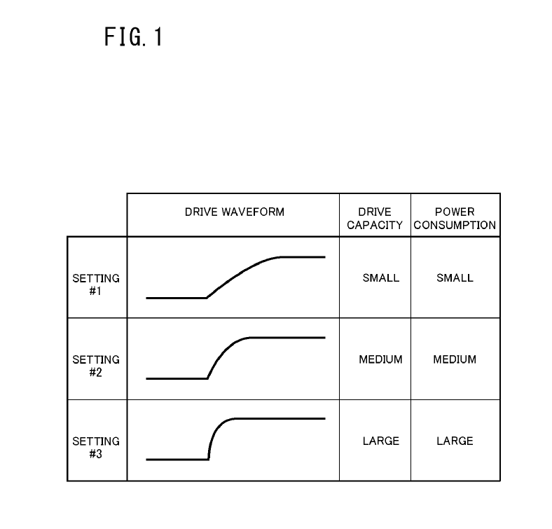

FIG. 2 is a block diagram illustrating an exemplary configuration of a liquid crystal display device according to a first embodiment of the present invention;

FIG. 3 is a circuit diagram conceptually illustrating an exemplary configuration of subpixels;

FIG. 4 conceptually illustrates an exemplary configuration of a circuit block of a source driver IC of the liquid crystal display device, relevant to measurement of the delay characteristics of source lines and driving of source lines according to the first embodiment;

FIG. 5 is a block diagram illustrating an example of the configurations of a source drive circuit, a drive circuit, and a delay calculating block according to the first embodiment;

FIG. 6 is a circuit diagram illustrating an example of the configuration of an output amplifier;

FIG. 7 is a circuit diagram illustrating an example of the configuration of a drive capacity control circuit;

FIG. 8 is a flow chart illustrating an exemplary procedure for adjusting the drive capacity of the output amplifiers of the source drive circuit according to the first embodiment;

FIG. 9 is a timing chart illustrating exemplary operations of the drive circuit and the delay calculating block according to the first embodiment;

FIG. 10 is a block diagram illustrating a variation of the configuration of the liquid crystal display device according to the first embodiment;

FIG. 11 conceptually illustrates an example of a configuration of a gate driver IC adapted to adjust the drive capacity of a drive circuit for driving gate lines;

FIG. 12 is a block diagram illustrating an example of the configurations of the gate drive circuit, the drive circuit, and the delay calculating block of the gate driver IC illustrated in FIG. 11;

FIG. 13 is a flow chart illustrating an exemplary procedure for adjusting the drive capacity of an output circuit of the gate drive circuit of the gate driver IC illustrated in FIG. 11;

FIG. 14 is a timing chart illustrating an exemplary operation of the drive circuit and the delay calculating block of the gate driver IC illustrated in FIG. 11;

FIG. 15 is a block diagram illustrating an example of the configurations of a source drive circuit, a drive circuit, and a delay calculating block according to a second embodiment of the present invention;

FIG. 16 is a timing chart illustrating an exemplary operation of the drive circuit and the delay calculating block according to the second embodiment;

FIG. 17 is a block diagram specifically illustrating an exemplary configuration of a drive capacity adjustment logic circuit of the delay calculating block according to the second embodiment;

FIG. 18 is a flow chart illustrating an exemplary procedure for adjusting the drive capacity of the output amplifiers of the source drive circuit according to the second embodiment;

FIG. 19 is a timing chart illustrating an exemplary operation of the drive circuit and the delay calculating block according to the second embodiment;

FIG. 20 is a block diagram illustrating an exemplary entire configuration of a liquid crystal display device according to a third embodiment of the present invention;

FIG. 21 is a block diagram illustrating an exemplary configuration of a source driver section of a TPC (touch panel controller)-embedded source driver IC according to the third embodiment;

FIG. 22 is a block diagram illustrating details of the configuration of a touch panel controller section of the TPC-embedded source driver IC according to the third embodiment;

FIG. 23 is a timing chart illustrating an example of the timing at which the drive capacity of output amplifiers of a source drive circuit is adjusted (the timing at which digital waveform data are generated by an A/D converter), according to the third embodiment;

FIG. 24 is a timing chart illustrating another example of the timing at which the drive capacity of output amplifiers of a source drive circuit is adjusted (the timing at which digital waveform data are generated by an A/D converter), according to the third embodiment; and

FIG. 25 is a timing chart illustrating still another example of the timing at which the drive capacity of output amplifiers of a source drive circuit is adjusted (the timing at which digital waveform data are generated by an A/D converter), according to the third embodiment.

### DETAILED DESCRIPTION

Embodiments of the present invention will be described below with reference to the attached drawings.

In an aspect of the present invention, a display device includes a display panel and a driver. The display panel includes a first interconnection connected to a plurality of subpixels which are used for image display, second and third interconnections each connected to a plurality of subpixels which are not used for the image display, and a bridge interconnection connecting the second and third interconnections. The driver includes a drive circuit driving the first interconnection. The drive capacity of the driver circuit is controlled on the waveform of an output signal outputted from the third interconnection when the second interconnection is driven.

### First Embodiment

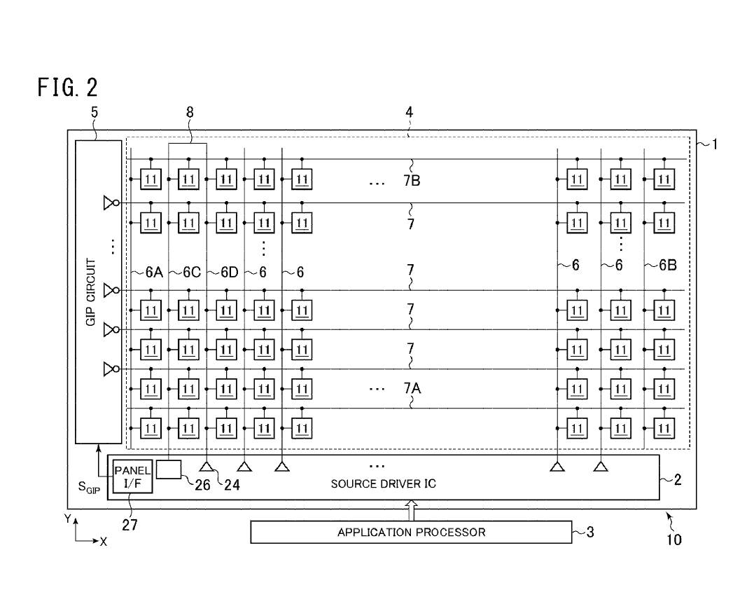

FIG. 2 is a block diagram illustrating an exemplary configuration of a liquid crystal display device 10 according to a first embodiment of the present invention. The liquid crystal display device 10 includes a liquid crystal display panel 1 and a source driver IC 2, and is configured to drive the liquid crystal display panel 1 in response to image data and control data received from an application processor 3.

The liquid crystal display panel 1 includes a pixel arrangement region 4 and a GIP (gate in panel) circuit 5. The pixel arrangement region 4 includes a plurality of source lines 6 (also referred to as signal lines or data lines), a plurality of gate lines 7 (also referred to as scanning lines or address lines) and subpixels 11 arranged in rows and columns. The source lines 6 and the gate lines 7 are provided to perpendicularly intersect with each other. The direction in which the gate lines 7 are extended may be hereinafter referred to as the “horizontal direction” and the direction in which the source lines 6 are extended may be hereinafter referred to as the “vertical direction”. The source lines 6, which are extended in the vertical direction, are arrayed in the horizontal direction, and the gate lines 7, which are extended in the horizontal direction, are arrayed in the vertical direction. Each of the subpixels 11 displays one of red (R), green (G), and blue (B), and each pixel in the liquid crystal display panel 1 includes three subpixels 11 that display red (R), green (G), and blue (B), respectively. The GIP circuit 5 drives the gate lines 7 in response to gate control signals S_{GIP} supplied from the source driver IC 2. The GIP circuit 5 may be integrated on the liquid crystal display panel 1 with a COG (circuit-on-glass) technology, for example.

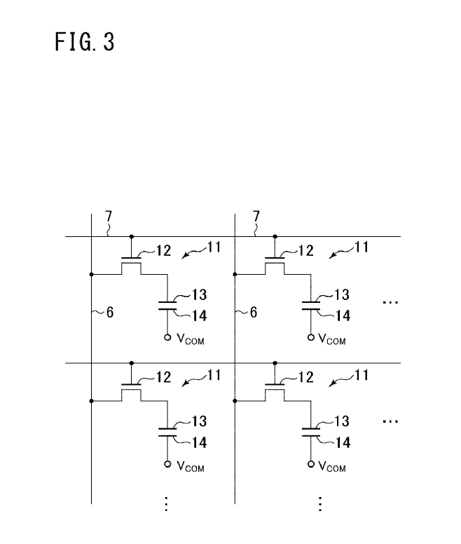

FIG. 3 is a circuit diagram illustrating an example of the configuration of the subpixels 11. The circuit diagram conceptually illustrates the structure of the subpixels 11. Each subpixel 11 includes a TFT (thin film transistor) 12 and a pixel electrode 13. The source, gate, and drain of the TFT 12 are connected to the source line 6, the gate line 7, and the pixel electrode 13, respectively. The pixel electrode 13 is opposed to a counter electrode 14 (also referred to as common electrode) of the liquid crystal display panel 1, and the space between the pixel electrode 13 and the counter electrode 14 is filled with liquid crystal. Although the counter electrode 14 is illustrated as being individually provided for each of the subpixels 11 in FIG. 3, a person having ordinary skill in the art would understand that one common counter electrode 14 shared by a plurality of subpixels 11 (for example, one counter electrode 14 is shared by the subpixels 11 of the entire liquid crystal display panel 1) is provided in an actual implementation.

Referring back to FIG. 2, the pixel arrangement region 4 further includes two dummy source lines 6A and 6B and two characteristic measurement source lines 6C and 6D. The dummy source lines 6A and 6B and the two characteristic measurement source lines 6C and 6D have the same structure as the source lines 6, and subpixels 11 are connected to the dummy source lines 6A and 6B and the two characteristic measurement source lines 6C and 6D as is the case with the source lines 6. It should be noted however that the subpixels 11 that are connected to the dummy source lines 6A and 6B and the characteristic measurement source lines 6C and 6D are not used for image display. The dummy source lines 6A and 6B are positioned in the vicinity of both ends of the pixel arrangement region 4 in the horizontal direction, and the source lines 6 and the characteristic measurement source lines 6C and 6D are provided between the dummy source lines 6A and 6B. The dummy source lines 6A and 6B are provided to address variations induced in the process of forming source lines on the liquid crystal display panel 1. In general, the process of forming source lines and gate lines on a liquid crystal display panel is performed by etching. In the etching, the source lines and gate lines positioned at the both ends may be formed to have different dimensions (e.g. the width) from the source lines and gate lines positioned in the middle. This implies that the sources lines and gate lines positioned at the both ends may have different characteristics from the source lines and gate lines positioned in the middle. The dummy source lines 6A and 6B effectively address this problem.

The pixel arrangement region 4 further includes two dummy gate lines 7A and 7B. The dummy gate lines 7A and 7B are provided to address variations induced in the process of forming gate lines on the liquid crystal display panel 1 as is the case with the dummy source lines 6A and 6B. The dummy gate lines 7A and 7B are positioned in the vicinity of the both ends of the pixel arrangement region 4 in the vertical direction, and the gate lines 7 are provided between the dummy gate lines 7A and 7B. The dummy gate lines 7A and 7B have the same structure as the gate lines 7, and subpixels 11 are connected to the dummy gate lines 7A and 7B as is the case with the gate lines 7. It should be noted however that the subpixels 11 connected to the dummy gate lines 7A and 7B are not used for image display.

The characteristic measurement source lines 6C and 6D are interconnections used for measuring characteristics of the liquid crystal display panel 1, especially the delay characteristics of the source lines 6. The respective one ends of the characteristic measurement source lines 6C and 6D are connected to the source driver IC 2, and the respective other ends of the characteristic measurement source lines 6C and 6D located away from the source driver IC 2 are connected with each other via a bridge interconnection 8. When a signal is inputted to the end of the characteristic measurement source line 6D connected to the source driver IC 2, the signal is outputted from the end of the characteristic measurement source line 6C connected to the source driver IC 2. In the present embodiment, the characteristic measurement source lines 6C and 6D are adjacent to each other and therefore the length of the bridge interconnection 8 is extremely small compared with the lengths of the characteristic measurement source lines 6C and 6D. Note that the bridge interconnection 8 does not need to be connected to the exact ends of the characteristic measurement source lines 6C and 6D; the bridge interconnection 8 may be connected in the vicinity of the ends of the characteristic measurement source lines 6C and 6D.

In the present embodiment, as described later, a step signal outputted from the source driver IC 2 is inputted to the characteristic measurement source line 6D, and the waveform of the output signal outputted from the characteristic measurement source line 6C is observed. The drive capacity of a drive circuit that drives the source lines 6 of the source driver IC 2 is adjusted in response to the waveform of the output signal, thereby optimizing the drive capacity of the drive circuit.

Although the characteristic measurement source lines 6C and 6D are adjacent to the dummy source line 6A in the configuration illustrated in FIG. 2, the characteristic measurement source lines 6C and 6D may be provided at any position between the dummy source lines 6A and 6B. It should be noted however that, when the characteristic measurement source lines 6C and 6D, which are not used for image display, are provided at positions in the middle of the pixel arrangement region 4, a line may be observed at the position where the characteristic measurement source lines 6C and 6D are provided in an image displayed on the pixel arrangement region 4. Therefore, it is preferable that the characteristic measurement source lines 6C and 6D be positioned adjacent to the dummy source line 6A or 6B.

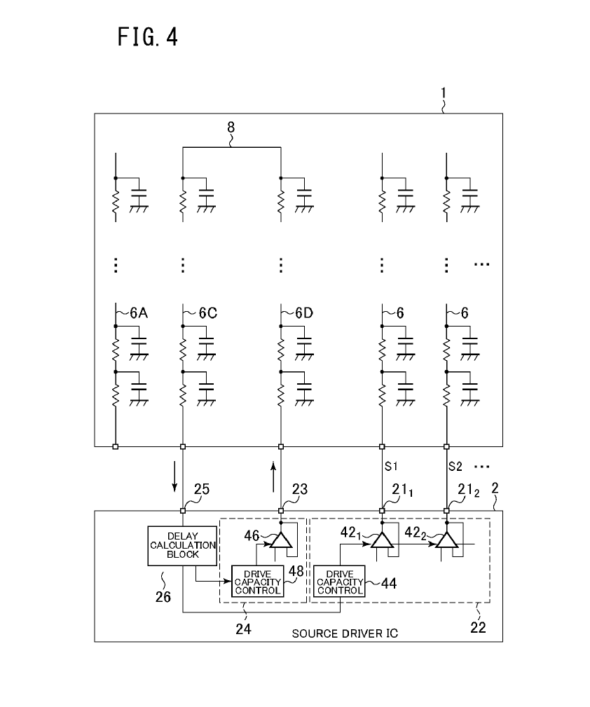

FIG. 4 conceptually illustrates an exemplary configuration of a circuit block of the source driver IC 2 relevant to the observation of the waveform of the signal outputted from the characteristic measurement source line 6C and the driving of the source lines 6. The source driver IC 2 includes source outputs 21, a source drive circuit 22, a measurement output pad 23, a drive circuit 24, a measurement input pad 25, and a delay calculating block 26. The source outputs 21 are external connection pads connected to the source lines 6. Note that subscripts may be attached to the reference numeral “21” when the source outputs 21 are distinguished from each other. Although only the two source outputs 21₁ and 21₂ are shown in FIG. 4, a person skilled in the art would appreciate that a large number of source outputs may be provided in an actual implementation. The source drive circuit 22 drives the source lines 6 connected to the source outputs 21.

The measurement output pad 23 is an external connection pad connected to the characteristic measurement source line 6D, and the drive circuit 24 drives the characteristic measurement source line 6D connected to the measurement output pad 23. As described later, the drive circuit 24 is used to supply a step signal to the characteristic measurement source line 6D in the measurement of delay characteristics of the source lines 6.

The measurement input pad 25 is an external connection pad connected to the characteristic measurement source line 6C, and the delay calculating block 26 observes the waveform of the output signal outputted from the characteristic measurement source line 6C connected to the measurement input pad 25. The delay calculating block 26 operates as a drive capacity controlling section for adjusting the drive capacity of the source drive circuit 22, which drives the source lines 6, in response to the waveform of the output signal outputted from the characteristic measurement source line 6C.

In the present embodiment, the delay calculating block 26 measures the delay characteristics of the source lines 6, which are information obtained from the waveform of the output signal outputted from the characteristic measurement source line 6C. The delay characteristics of the source lines 6 are useful information for appropriately adjusting the drive capacity of the source drive circuit 22 that drives the source lines 6.

More specifically, the delay calculating block 26 measures the delay time across the characteristic measurement source lines 6C and 6D and the bridge interconnection 8. Since the length of the bridge interconnection 8 connecting the characteristic measurement source lines 6C and 6D is extremely small compared with the lengths of the characteristic measurement source lines 6C and 6D, the delay calculating block 26 substantially measures the delay time across the characteristic measurement source lines 6C and 6D. Additionally, since the characteristic measurement source lines 6C and 6D have the same structure as the source lines 6 and subpixels 11 are connected to the characteristic measurement source lines 6C and 6D as is the case with the source lines 6, the characteristic measurement source lines 6C and 6D effectively simulate the source lines 6 used for image display. Therefore, the delay time across the characteristic measurement source lines 6C and 6D reflects the delay characteristics of the source lines 6 used for image display, and the drive capacity can be appropriately adjusted by adjusting the drive capacity of the source drive circuit 22 for driving the source lines 6 in response to the delay time across the characteristic measurement source lines 6C and 6D.

Although the drive circuit 24 drives the characteristic measurement source line 6D and the delay calculating block 26 observes the waveform of the output signal outputted from the characteristic measurement source line 6C in the configuration illustrated in FIGS. 2 and 4, the configuration may be modified so that the drive circuit 24 drives the characteristic measurement source line 6C and the delay calculating block 26 observes the waveform of the output signal outputted from the characteristic measurement source line 6D.

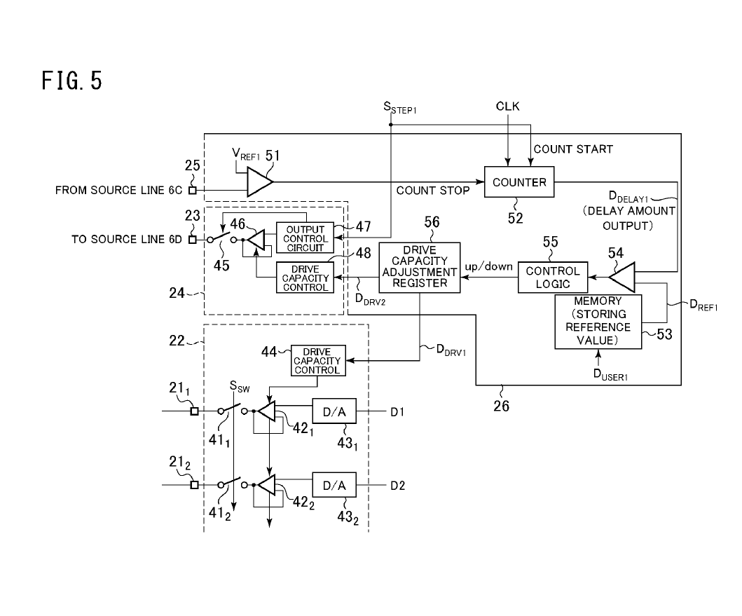

FIG. 5 is a block diagram illustrating an example of the configurations of the source drive circuit 22, the drive circuit 24, and the delay calculating block 26. The source drive circuit 22 includes output switches 41, output amplifiers 42, D/A converters 43, and a drive capacity control circuit 44. Note that subscripts may be attached to the reference numeral “41” when the output switches 41 are distinguished from each other. In FIG. 5, two output switches 41₁ and 41₂ are illustrated. Similarly, subscripts may be attached to the reference numeral “43” when the output amplifiers 42 and D/A converters 43 are distinguished from each other.

The output switches 41 are disposed between the outputs of the output amplifiers 42 and the source outputs 21, to electrically connect or disconnect the outputs of the output amplifiers 42 with or from the source outputs 21 in response to a control signal S_{SW}. The output switches 41 electrically connect the output amplifiers 42 to the source outputs 21 when the source lines 6 connected to the source outputs 21 are to be driven.

The output amplifiers 42 output voltages which correspond to (basically, the same voltages as) grayscale voltages received from the D/A converters 43. The output amplifiers 42 are each configured as a voltage follower. The voltages outputted from the output amplifiers 42 are used as drive voltages for driving the source lines 6. As described later, the output amplifiers 42 are configured so that the drive capacity thereof is adjustable.

The D/A converters 43 perform digital-analog conversion on image data, which are digital data, to output analog grayscale voltages which correspond to the grayscale levels of the subpixels 11 indicated by the image data.

The drive capacity control circuit 44 controls the drive capacity of the output amplifiers 42 of the source drive circuit 22. In the present embodiment, as described later, the drive capacity control circuit 44 controls the drive capacity of the output amplifiers 42 by adjusting a bias voltage supplied to each output amplifier 42. The control of the drive capacity by the drive capacity control circuit 44 is performed in accordance with a drive capacity specifying value D_{DRV1} supplied from the delay calculating block 26. Here, the drive capacity specifying value D_{DRV1} is a value which specifies the drive capacity of the output amplifiers 42.

Schematically, the source drive circuit 22 drives the source lines 6 in the operation described below. When the source lines 6 are driven, the output switches 41 are set to the on-state. Additionally, image data Dᵢ which indicate the grayscale level of the subpixel 11 connected to the source line 6 which is connected to the source output 21ᵢ are inputted to the D/A converter 43ᵢ (i=1, 2, . . . ), and the D/A converter 43ᵢ outputs the grayscale voltage corresponding to the grayscale level indicated by the image data Dᵢ. The output amplifier 42ᵢ outputs the drive voltage corresponding to (basically the same voltage as) the grayscale voltage received from the D/A converter 43ᵢ. The drive voltage outputted from the output amplifier 42ᵢ is outputted to the source line 6 connected to the source output 21ᵢ, and written into the subpixel 11 which is connected to that source line 6 and a selected gate line 7.

The drive circuit 24 includes an output switch 45, an output amplifier 46, an output control circuit 47, and a drive capacity control circuit 48. The output switch 45 is connected between the output of the output amplifier 46 and the measurement output pad 23, and electrically connects or disconnects the output of the output amplifier 46 with or from the measurement output pad 23 in response to a control signal supplied from the output control circuit 47. The output switch 45 electrically connects the output amplifier 46 to the measurement output pad 23, when the characteristic measurement source line 6D connected to the measurement output pad 23 is driven.

The output amplifier 46 is formed as a voltage follower, and outputs the voltage corresponding to (basically the same voltage as) the voltage received from the output control circuit 47. The output amplifier 46 has the same configuration as the output amplifiers 42 of the source drive circuit 22. As described later, the output amplifier 46 is configured so that the drive capacity thereof is adjustable.

The output control circuit 47 controls the output switch 45 and the output amplifier 46 in response to a step output signal S_{STEP1}. Here, the step output signal S_{STEP1} is a control signal which instructs to output a step signal to the characteristic measurement source line 6D. When the step output signal S_{STEP1} is asserted in measuring the delay time across the characteristic measurement source lines 6C and 6D and the bridge interconnection 8, the output control circuit 47 supplies a predetermined voltage to the input of the output amplifier 46, and turns on the output switch 45. This allows supplying a step signal from the output amplifier 46 to the characteristic measurement source line 6D via the measurement output pad 23.

The drive capacity control circuit 48 controls the drive capacity of the output amplifier 46. In the present embodiment, as described below, the drive capacity control circuit 48 adjusts a bias voltage supplied to the output amplifier 46 to thereby control the drive capacity of the output amplifier 46. The control of the drive capacity by the drive capacity control circuit 48 is performed in accordance with a drive capacity specifying value D_{DRV2} supplied from the delay calculating block 26. The drive capacity specifying value D_{DRV2} is a value which specifies the drive capacity of the output amplifier 46.

The delay calculating block 26 includes a comparator 51, a counter 52, a memory 53, a comparator 54, a control logic circuit 55, and a drive capacity adjustment register 56.

The comparator 51 receives the output signal outputted from the characteristic measurement source line 6C via the measurement input pad 25, and compares the voltage level of the received output signal with a predetermined threshold level V_{REF1}. The output signal of the comparator 51 indicates the comparison result between the voltage level of the output signal outputted from the characteristic measurement source line 6C and the threshold level V_{REF1}. In the present embodiment, the comparator 51 asserts the output signal thereof when the voltage level of the output signal outputted from the characteristic measurement source line 6C is higher than the threshold level V_{REF1}.

The counter 52 counts a clock signal CLK (i.e. counts up a count value which the counter 52 holds in synchronization with the clock signal CLK), and outputs the count value to one input of the comparator 54. The start of the counting operation of the counter 52 is controlled by the step output signal S_{STEP1}; the counter 52 starts the counting operation when the step output signal S_{STEP1} is asserted. On the other hand, the stop of the counting operation of the counter 52 is controlled by the output signal of the comparator 51; the counter 52 stops the counting operation when the output signal of the comparator 51 is asserted. Since the output signal of the comparator 51 is asserted when the voltage level of the output signal outputted from the characteristic measurement source line 6C is higher than the threshold level V_{REF1} as described above, the counter 52 stops the counting operation when the voltage level of the output signal outputted from the characteristic measurement source line 6C becomes higher than the threshold level V_{REF1}.

The count value at the time when the counter 52 stops the counting operation corresponds to the delay time of the characteristic measurement source lines 6C and 6D and the bridge interconnection 8. The count value at the time when the counting operation is stopped is increased when the delay time of the characteristic measurement source lines 6C and 6D and the bridge interconnection 8 is increased, and the count value at the time when the counting operation is stopped is decreased when the delay time of the characteristic measurement source lines 6C and 6D and the bridge interconnection 8 is decreased. The counter 52 supplies the count value at the time when the counting operation is stopped to the comparator 54 as a delay amount output D_{DELAY1}. As described later, the drive capacity of the output amplifiers 42 of the source drive circuit 22 is adjusted on the basis of the delay time of the characteristic measurement source lines 6C and 6D and the bridge interconnection 8, i.e. the delay amount output D_{DELAY1}.

The memory 53 holds a reference value D_{REF1} which corresponds to a reference delay time (a desired delay time) of the characteristic measurement source lines 6C and 6D and the bridge interconnection 8. The reference delay time held by the memory 53 is set by the user. In detail, user setting data D_{USER1} describing the reference value D_{REF1} is externally fed (e.g. from the application processor 3) to the source driver IC 2, and the reference value D_{REF1} described in the user setting data D_{USER1} is written into the memory 53.

The comparator 54 compares the delay amount output D_{DELAY1} received from the counter 52 with the reference value D_{REF1} received from the memory 53. The output signal of the comparator 54 corresponds to the comparison result between the delay amount output D_{DELAY1} and the reference value D_{REF1}.

The control logic circuit 55 adjusts register values held by the drive capacity adjustment register 56 in response to the output signal of the comparator 54. The register values held by the drive capacity adjustment register 56 include a drive capacity specifying value D_{DRV1} which specifies the drive capacity of the output amplifiers 42 of the source drive circuit 22 and a drive capacity specifying value D_{DRV2} which specifies the drive capacity of the output amplifier 46 of the drive circuit 24. The drive capacity specifying value D_{DRV1} is supplied to the drive capacity control circuit 44 of the source drive circuit 22, and the drive capacity specifying value D_{DRV2} is supplied to the drive capacity control circuit 48 of the drive circuit 24.

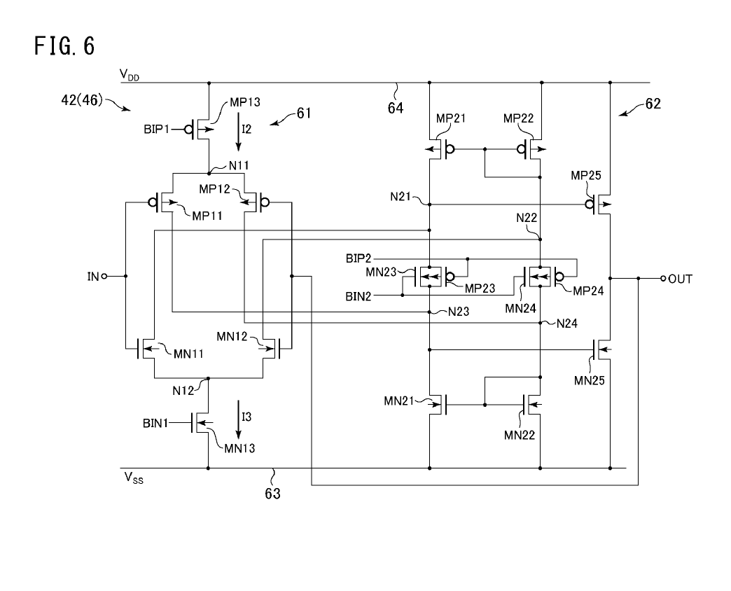

FIG. 6 is a circuit diagram illustrating an example of the configuration of the output amplifiers 42. The output amplifiers 42 each include a differential stage 61 and an output stage 62.

The differential stage 61 includes PMOS transistors MP11 to MP13 and NMOS transistors MN11 to MN13.

The PMOS transistors MP11 and MP12 form a differential transistor pair. The sources of the PMOS transistors MP11 and MP12 are commonly connected to a node N11 of the differential stage 61, and the drains thereof are connected to nodes N23 and N24 of the output stage 62, respectively. The gate of the PMOS transistor MP11 is connected to an input terminal IN, and the gate of the PMOS transistor MP12 is connected to an output terminal OUT.

The PMOS transistor MP13 operates as a constant current source which supplies a constant current I2 to the differential transistor pair formed of the PMOS transistors MP11 and MP12. The source of the PMOS transistor MP13 is connected to a positive power line 64 having the power supply level V_{DD}, and the drain of the PMOS transistor MP13 is connected to a node N11 (i.e. the sources of the PMOS transistors MP11 and MP12). A bias voltage BIP1 is supplied to the gate of the PMOS transistor MP13.

The NMOS transistors MN11 and MN12 form another differential transistor pair. The sources of the NMOS transistors MN11 and MN12 are commonly connected to a node N12 of the differential stage 61, and the drains of the NMOS transistors MN11 and MN12 are connected to nodes N21 and N22 of the output stage 62, respectively. The gate of the NMOS transistor MN11 is connected to the input terminal IN and the gate of the NMOS transistor MN12 is connected to the output terminal OUT.

The NMOS transistor MN13 operates as a constant current source which supplies a constant current I3 to the differential transistor pair formed of the NMOS transistors MN11 and MN12. The source of the NMOS transistor MN13 is connected to a negative power line 63 having the ground level V_{SS}, and the drain of the NMOS transistor MN13 is connected to the node N12 (i.e. the sources of the NMOS transistors MN11 and MN12). A bias voltage BIN1 is supplied to the gate of the NMOS transistor MN13.

The output stage 62 includes PMOS transistors MP21 to MP25 and NMOS transistors MN21 to MN25.

The PMOS transistors MP21 and MP22 form a current mirror. The sources of the PMOS transistors MP21 and MP22 are commonly connected to the positive power line 64 and the drains of the PMOS transistors MP21 and MP22 are connected to the nodes N21 and N22, respectively. The gates of the PMOS transistors MP21 and MP22 are commonly connected to the node N22 (i.e. the drain of the PMOS transistor MP22).

The NMOS transistors MN21 and MN22 form another current mirror. The sources of the NMOS transistors MN21 and MN22 are commonly connected to the negative power line 63 and the drains of the NMOS transistors MN21 and MN22 are connected to the nodes N23 and N24, respectively. The gates of the NMOS transistors MN21 and MN22 are commonly connected to the node N24 (i.e. the drain of the NMOS transistor MN22).

The PMOS transistor MP23 and the NMOS transistor MN23 form a floating current source connected between the nodes N21 and N23. The source of the PMOS transistor MP23 and the drain of the NMOS transistor MN23 are commonly connected to the node N21, and the drain of the PMOS transistor MP23 and the source of the NMOS transistor MN23 are commonly connected to the node N23.

The PMOS transistor MP24 and the NMOS transistor MN24 form another floating current source connected between the nodes N22 and N24. The source of the PMOS transistor MP24 and the drain of the NMOS transistor MN24 are commonly connected to the node N22, and the drain of the PMOS transistor MP24 and the source of the NMOS transistor MN24 are commonly connected to the node N24.

Currents flowing through the two floating current sources are dependent on a bias voltage BIP2 supplied to the gates of the PMOS transistors MP23 and MP24, and a bias voltage BIN2 supplied to the gates of the NMOS transistors MN23 and MN24.

The PMOS transistor MP25 and the NMOS transistor MN25 operate as output transistors for driving the output terminal OUT. The source, drain, and gate of the PMOS transistor MP25 are connected to the positive power line 64, the output terminal OUT, and the node N21, respectively. The source, drain, and gate of the NMOS transistor MN25 are connected to the negative power line 63, the output terminal OUT, and the node N23, respectively.

The grayscale voltage outputted from the D/A converter 43ᵢ is inputted to the input terminal IN of the output amplifier 42ᵢ, and the voltage outputted from the output terminal OUT is used as the drive voltage which drives the source line 6 connected to the source output 21ᵢ.

The output amplifier 46 has the same configuration as the output amplifiers 42. It should be noted however that, for the output amplifier 46, the voltage received from the output control circuit 47 is inputted to the input terminal IN, and the voltage outputted from the output terminal OUT is supplied to the characteristic measurement source line 6D connected to the measurement output pad 23.

In one embodiment, the control of the drive capacity of the output amplifiers 42 and 46 may be performed by controlling the bias voltages BIP1 and BIN1 supplied to the PMOS transistor MP13 and the NMOS transistor MN13 of the output amplifiers 42 and 46, respectively. The current I2 flowing through the PMOS transistor MP13 (i.e. the current supplied to the differential transistor pair formed of the PMOS transistors MP11 and MP12) is adjusted by controlling the bias voltage BIP1, and the current I3 flowing through the NMOS transistor MN13 (i.e. the current drawn from the differential transistor pair formed of the NMOS transistors MN11 and MN12) is adjusted by controlling the bias voltage BIN1. The drive capacity control circuit 44 controls the drive capacity of the output amplifiers 42 by controlling the bias voltages BIP1 and BIN1 supplied to the output amplifiers 42. Similarly, the drive capacity control circuit 48 controls the drive capacity of the output amplifier 46 by controlling the bias voltages BIP1 and BIN1 supplied to the output amplifier 46.

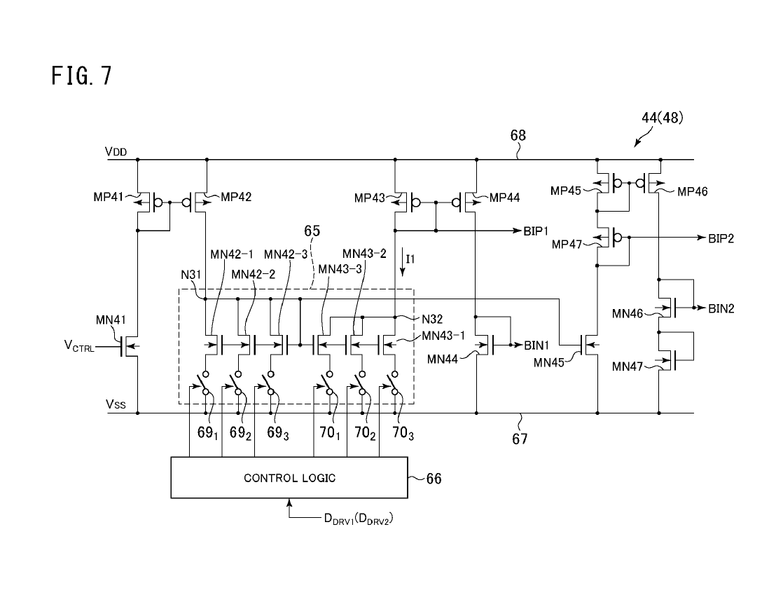

FIG. 7 illustrates an example of the configuration of the drive capacity control circuit 44 configured to control the bias voltages BIP1 and BIN1. Note that the drive capacity control circuit 44 also has the function of supplying the bias voltages BIP2 and BIN2 in addition to the bias voltages BIP1 and BIN1. The drive capacity control circuit 44 includes PMOS transistors MP41 to MP47, NMOS transistors MN41 and MN44 to MN47, a variable current mirror 65, and a control logic circuit 66.

The NMOS transistor MN41 operates as a constant current source. The source of the NMOS transistor MN41 is connected to a negative power line 67 having the ground level V_{SS}, and a control bias voltage V_{CTRL} is supplied to the gate of the NMOS transistor MN41.

The PMOS transistors MP41 and MP42 form a current mirror. The sources of the PMOS transistors MP41 and MP42 are commonly connected to a positive power line 68, and the gates of the PMOS transistors MP41 and MP42 are commonly connected to the drain of the PMOS transistor MP41. The drain of the PMOS transistor MP41 is connected to the drain of the NMOS transistor MN41, and the drain of the PMOS transistor MP42 is connected to a node N31 (the input node of the variable current mirror 65, which will be described later).

The variable current mirror 65 generates a current I1 which is proportional to the current flowing into the node N31 and flowing through the node N32. Here, the variable current mirror 65 is configured so that the mirror ratio is adjustable, and the current I1 is adjustable with the mirror ratio.

More specifically, the variable current mirror 65 includes NMOS transistors MN42-1 to MN42-3, switches 69₁ to 69₃, NMOS transistors MN43-1 to MN43-3, and switches 70₁ to 70₃. The gates of the NMOS transistors MN42-1 to MN42-3 and MN43-1 to MN43-3 are commonly connected to the node N31. The NMOS transistor MN42-1 and the switch 69₁ are connected in series between the node N31 and the negative power line 67, forming a first current adjusting leg. Similarly, the NMOS transistor MN42-2 and the switch 69₂ are connected in series between the node N31 and the negative power line 67, forming a second current adjusting leg, and the NMOS transistor MN42-3 and the switch 69₃ are connected in series between the node N31 and the negative power line 67, forming a third current adjusting leg. The first, second and third current adjusting legs are connected in parallel between the node N31 and the negative power line 67. The NMOS transistor MN43-1 and the switch 70₁ are connected in series between the node N32 and the negative power line 67, forming a fourth current adjusting leg. Similarly, the NMOS transistor MN43-2 and the switch 70₂ are connected in series between the node N32 and the negative power line 67, forming a fifth current adjusting leg, and the NMOS transistor MN43-3 and the switch 70₃ are connected in series between the node N32 and the negative power line 67, forming a sixth current adjusting leg. The fourth, fifth and sixth current adjusting legs are connected in parallel between the node N32 and the negative power line 67.

The mirror ratio of the variable current mirror 65 thus configured is dependent on the ratio of the sum of the gate widths of the NMOS transistors with the connected switches (69₁ to 69₃) being in the on-state among the NMOS transistors MN42-1 to MN42-3, to the sum of the gate widths of the NMOS transistors with the connected switches (70₁ to 70₃) being in the on-state among the NMOS transistors MN43-1 to MN43-3. Therefore, the mirror ratio of the variable current mirror 65, i.e. the current I1, can be adjusted by controlling the turn-on and -off of each of the switches 69₁ to 69₃ and 70₁ to 70₃.

Although the switches 69₁ to 69₃ are illustrated as being connected between the sources of the NMOS transistors MN42-1 to MN42-3 and the negative power line 67 in FIG. 7, the switches 69₁ to 69₃ may be connected between the node N31 and the drains of the NMOS transistors MN42-1 to MN42-3 instead. Similarly, the switches 70₁ to 70₃ may be connected between the node N32 and the drains of the NMOS transistors MN43-1 to MN43-3 instead, although the switches 70₁ to 70₃ are illustrated as being connected between the sources of the NMOS transistors MN43-1 to MN43-3 and the negative power line 67 in FIG. 7.

The PMOS transistors MP43 and MP44 form a current mirror which generates the bias voltage BIP1 in response to the current I1. The sources of the PMOS transistors MP43 and MP44 are commonly connected to the positive power line 68, and the gates thereof are commonly connected to the drain of the PMOS transistor MP43. The drain of the PMOS transistor MP43 is connected to the node N32 of the variable current mirror 65. The voltage generated on the drain of the PMOS transistor MP43 is outputted as the bias voltage BIP1. Since the current I1 is controlled on the mirror ratio of the variable current mirror 65 as described above, the bias voltage BIP1 is controlled on the mirror ratio of the variable current mirror 65.

The NMOS transistor MN44 is diode-connected, and is used to generate the bias voltage BIN1 in response to the current I1. The source of the NMOS transistor MN44 is connected to the negative power line 67, and the drain of the NMOS transistor MN44 is connected to the drain of the PMOS transistor MP44. The gate of the NMOS transistor MN44 is connected to the drain thereof, and the voltage generated on the gate of the NMOS transistor MN44 is outputted as the bias voltage BIN1. Since the current I1 is controlled on the mirror ratio of the variable current mirror 65 as described above, the bias voltage BIN1 is controlled on the mirror ratio of the variable current mirror 65.

The PMOS transistors MP45 to MP47 and the NMOS transistors MN45 to MN47 form a circuitry for generating the bias voltages BIP2 and BIN2 to be supplied to the output stage 62 of the output amplifier 42 from the voltage level of the node N31. The source, gate, and drain of the NMOS transistor MN45 are connected to the negative power line 67, the node N31, and the drain of the PMOS transistor MP47, respectively. The PMOS transistors MP45 and MP46 form a current mirror. The sources of the PMOS transistors MP45 and MP46 are commonly connected to the positive power line 68, and the gates of the PMOS transistors MP45 and MP46 are commonly connected to the drain of the PMOS transistor MP45. The source of the PMOS transistor MP47 is connected to the drain of the PMOS transistor MP45, and the drain of the PMOS transistor MP47 is connected to the drain of the NMOS transistor MN45. The PMOS transistor MP47 is diode-connected, and the gate of the PMOS transistor MP47 is connected to the drain thereof. The voltage generated on the gate of the PMOS transistor MP47 is outputted as the bias voltage BIP2. The drain of the NMOS transistor MN46 is connected to the drain of the PMOS transistor MP46, and the source of the NMOS transistor MN46 is connected to the drain of the NMOS transistor MN47. The NMOS transistor MN46 is diode-connected, and the gate of the NMOS transistor MN46 is connected to the drain thereof. The voltage generated on the gate of the NMOS transistor MN46 is outputted as the bias voltage BIN2. The NMOS transistor MN47 is diode-connected, and the gate of the NMOS transistor MN47 is connected to the drain thereof. The source of the NMOS transistor MN47 is connected to the negative power line 67.

The control logic circuit 66 adjusts the mirror ratio of the variable current mirror 65 in response to the drive capacity specifying value D_{DRV1} supplied from the delay calculating block 26, thereby controlling the drive capacity of the output amplifier 42. The control logic circuit 66 controls the turn-on and -off of each of the switches 69₁ to 69₃ and 70₁ to 70₃ in response to the drive capacity specifying value D_{DRV1}, thereby adjusting the mirror ratio of the variable current mirror 65. As described above, the bias voltages BIP1 and BIN1 are controlled on the mirror ratio of the variable current mirror 65 to thereby control the drive capacity of the output amplifier 42.

In the present embodiment, the drive capacity control circuit 48 has the same configuration as the drive capacity control circuit 44. In this case, the drive capacity control circuit 48 controls the turn-on and -off of each of the switches 69₁ to 69₃ and 70₁ to 70₃ in response to the drive capacity specifying value D_{DRV2}, thereby adjusting the mirror ratio of the variable current mirror 65. As described above, the bias voltages BIP1 and BIN1 are controlled on the mirror ratio of the variable current mirror 65 to thereby control the drive capacity of the output amplifier 46.

The control of the drive capacity of the output amplifiers 42 and 46 are not limited to the above-described method, and the configurations of the drive capacity control circuits 44 and 48 are not limited to the above-described configuration. For example, the adjustment of the current I2 flowing through the PMOS transistor MP13 of the output amplifier 42 may be achieved through adjusting the mirror ratio of the current mirror formed of the PMOS transistor MP13 of the output amplifier 42 and the PMOS transistor MP43 of the drive capacity control circuit 44. In this case, the current mirror formed of the PMOS transistor MP13 of the output amplifier 42 and the PMOS transistor MP43 of the drive capacity control circuit 44 may be configured similarly to the variable current mirror 65. For example, the mirror ratio may be controlled by providing a plurality of current adjusting legs having PMOS transistors and switches connected in series in place of the PMOS transistor MP13 of the output amplifier 42, providing a plurality of current adjusting legs having PMOS transistors and switches connected in series in place of the PMOS transistor MP43, and controlling the switch of each of the current adjusting legs.

Similarly, the adjustment of the current I3 flowing through the NMOS transistor MN13 of the output amplifier 42 may be achieved by adjusting the mirror ratio of the current mirror formed of the NMOS transistor MN13 of the output amplifier 42 and the NMOS transistor MN44 of the drive capacity control circuit 44. In this case, the current mirror formed of the NMOS transistor MN13 of the output amplifier 42 and the NMOS transistor MN44 of the drive capacity control circuit 44 may be configured similarly to the variable current mirror 65. For example, the mirror ratio may be controlled by providing a plurality of current adjusting legs having NMOS transistors and switches connected in series in place of the NMOS transistor MN13 of the output amplifier 42, providing a plurality of current adjusting legs having NMOS transistors and switches connected in series in place of the NMOS transistor MN43, and controlling the switch of each of the current adjusting legs.

The drive capacity of the output amplifiers 42 and 46 may be adjusted by adjusting the output impedance through adjusting the effective gate widths of the output transistors of the output amplifiers 42 and 46. More specifically, the drive capacity of the output amplifiers 42 and 46 may be controlled by providing a plurality of current adjusting legs having PMOS transistors and switches connected in series in place of the PMOS transistor MP25 of the output stage 62 of the output amplifiers 42 and 46, providing a plurality of current adjusting legs having NMOS transistors and switches connected in series in place of the NMOS transistor MN25, and controlling the switch of each of the current adjusting legs.

Next, a detailed description is given of an exemplary operation of the source driver IC 2 according to the present embodiment, especially the operations of the drive circuit 24 and the delay calculating block 26 for adjusting the drive capacity of the output amplifiers 42 of the source drive circuit 22.

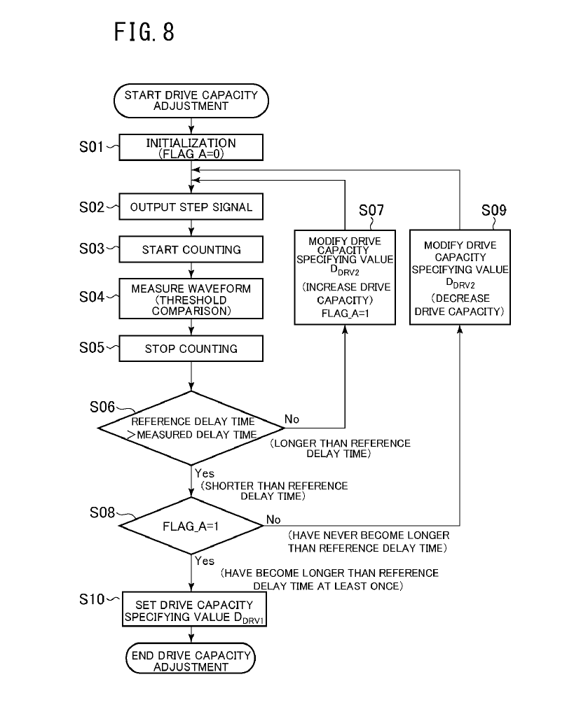

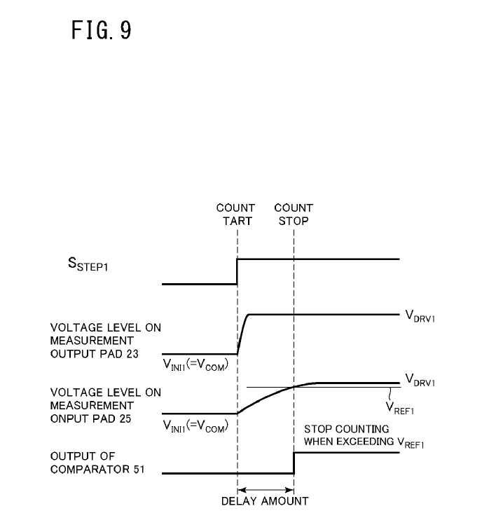

FIG. 8 is a flow chart illustrating the procedure for the delay calculating block 26 to adjust the drive capacity of the output amplifiers 42 of the source drive circuit 22, and FIG. 9 is a timing chart illustrating the operation of the drive circuit 24 and the delay calculating block 26 according to the present embodiment.

In the present embodiment, the drive capacity of the output amplifiers 42 is adjusted in response to the waveform of the output signal outputted from the end of the characteristic measurement source line 6C connected to the measurement input pad 25 when a step signal is inputted to the end of the characteristic measurement source line 6D connected to the measurement output pad 23. More specifically, the delay time across the characteristic measurement source lines 6C and 6D and the bridge interconnection 8 is calculated from the output signal outputted from the characteristic measurement source line 6C, and the drive capacity of the output amplifiers 42 is adjusted in response to the delay time across the characteristic measurement source lines 6C and 6D and the bridge interconnection 8. In the present embodiment, the drive capacity of the output amplifiers 42 is adjusted so that the delay time across the characteristic measurement source lines 6C and 6D and the bridge interconnection 8 becomes a value close to the reference delay time corresponding to the reference value D_{REF1} set to the memory 53. In the following, the procedure for adjusting the drive capacity of the output amplifiers 42 according to the present embodiment is described.

The procedure for adjusting the drive capacity of the output amplifiers 42 according to the present embodiment begins with initialization (step S01). In the initialization, the drive capacity specifying value D_{DRV2} held by the drive capacity adjustment register 56 of the delay calculating block 26 is first set to an initial value. This achieves an initial setting of the drive capacity of the output amplifier 46, since the drive capacity specifying value D_{DRV2} specifies the drive capacity of the output amplifier 46 of the drive circuit 24. Furthermore, a flag FLAG_A of the control logic circuit 55 of the delay calculating block 26 is reset (that is, the flag FLAG_A is set to “0”) and the counter 52 is initialized. Here, the flag FLAG_A indicates whether the delay time across the characteristic measurement source lines 6C and 6D and the bridge interconnection 8 has become longer than the reference delay time at least once in the following procedure. As described later, the flag FLAG_A is set (i.e. set to “1”) when the delay time across the characteristic measurement source lines 6C and 6D and the bridge interconnection 8 has become longer than the reference delay time.

In addition, the characteristic measurement source lines 6C and 6D are set to a predetermined initial voltage level V_{INI1} (most typically, the common level V_{COM}, i.e. the voltage level on the counter electrode 14). For example, the setting of the characteristic measurement source lines 6C and 6D to the initial voltage level V_{INI1} may be achieved by short-circuiting the measurement output pad 23 and the measurement input pad 25 to a node with the initial voltage level V_{INI1} via a switch (not shown). Alternatively, the characteristic measurement source lines 6C and 6D may be driven to the predetermined initial voltage level V_{INI1} (e.g. the ground level V_{SS} or the lowest one of the grayscale voltages) with the output amplifier 46 of the drive circuit 24. In this case, the output control circuit 47 drives the input of the output amplifier 46 to a voltage level which corresponds to the initial voltage level V_{INI1} (typically, the same voltage level as the initial voltage level V_{INI1}) with the output switch 45 turned on. This method does not require a switch for short-circuiting the characteristic measurement source lines 6C and 6D to the node having the initial voltage level V_{INI1} (e.g. a line having the common level V_{COM}), and is advantageous in terms of simplification of the circuit configuration.

Next, a drive voltage V_{DRV1} is outputted from the output amplifier 46 of the drive circuit 24 to the measurement output pad 23 to thereby drive the measurement output pad 23 to the voltage level V_{DRV1} (step S02). The drive voltage V_{DRV1} outputted from the output amplifier 46 to the measurement output pad 23 is adjusted so that the voltage level V_{DRv1} to which the measurement output pad 23 is finally driven is higher than the initial voltage level V_{INI1}. In other words, a step signal is outputted to the end of the characteristic measurement source line 6D connected to the measurement output pad 23. More specifically, when the step output signal S_{STEP1} is asserted, the same voltage as the drive voltage V_{DRV1} is supplied from the output control circuit 47 of the drive circuit 24 to the output of the output amplifier 46 and the output switch 45 of the drive circuit 24 is turned on as shown in FIG. 9. As a result, the drive voltage V_{DRV1} is outputted from the output amplifier 46 to the measurement output pad 23, and the measurement output pad 23 is driven to the voltage level V_{DRV1}.

In this operation, the measurement output pad 23 is promptly driven to the voltage level V_{DRV1}, whereas the voltage level on the measurement input pad 25 is driven to the voltage level V_{DRV1} later than the measurement output pad 23 due to the delay across the characteristic measurement source lines 6C and 6D and the bridge interconnection 8. In the operation at steps S03 to S05 described below, the delay time across the characteristic measurement source lines 6C and 6D and the bridge interconnection 8 is measured.

More specifically, the counter 52 starts counting an operation in response to the assertion of the step output signal S_{STEP1} as illustrated in FIG. 8 (step S03).

In the meantime, the comparator 51 compares the voltage level of the measurement input pad 25 with the predetermined threshold level V_{REF1} (step S04). In other words, the comparator 51 receives the output signal outputted from the characteristic measurement source line 6C via the measurement input pad 25, and compares the voltage level of the received output signal with the predetermined threshold level V_{REF1}. Here, the threshold level V_{REF1} is set to be lower than the voltage level V_{DRV1} to which the measurement output pad 23 is finally driven, and higher than the initial voltage level V_{INI1}. As illustrated in FIG. 9, the output of the comparator 51 is asserted when the voltage level of the measurement input pad 25 becomes higher than the threshold level V_{REF1}.

When the output of the comparator 51 is asserted, the counter 52 stops the counting operation (step S05). The count value held by the counter 52 at this moment corresponds to the delay time across the characteristic measurement source lines 6C and 6D and the bridge interconnection 8. The count value held by the counter 52 is outputted to the comparator 54 as the delay amount output D_{DELAY1}.

Furthermore, the comparator 54 compares the value of the delay amount output D_{DELAY1} outputted from the counter 52 with the reference value D_{REF1} held by the memory 53 (step S06). This operation is equivalent to the comparison of the measured delay time (the measured value of the delay time across the characteristic measurement source lines 6C and 6D and the bridge interconnection 8) with the reference delay time.

When the measured delay time is longer than the reference delay time, i.e. when the delay amount output D_{DELAY1} is greater than the reference value D_{REF1}, the flag FLAG_A is set (i.e. set to “1”) in the control logic circuit 55 and the drive capacity specifying value D_{DRV2} held by the drive capacity adjustment register 56 is modified by the control logic circuit 55 so that the drive capacity of the output amplifier 46 of the drive circuit 24 is increased (step S07). Subsequently, the procedure returns to step S02, and the operations of the steps S02 to S05 are repeated again. The comparison of the measured delay time with the reference delay time (step S06) is then performed.

When the measured delay time is determined as shorter than the reference delay time at the step S06, i.e. when the value of the delay amount output D_{DELAY1} is smaller than the reference value D_{REF1}, the control logic circuit 55 determines whether the flag FLAG_A is set (i.e. whether the flag FLAG_A is set to “1”) (step S08). When the flag FLAG_A is not set, i.e. when the delay time across the characteristic measurement source lines 6C and 6D and the bridge interconnection 8 has never become longer than the reference delay time, the drive capacity specifying value D_{DRV2} held by the drive capacity adjustment register 56 is modified by the control logic circuit 55 so that the drive capacity of the output amplifier 46 of the drive circuit 24 is reduced (step S09). Subsequently, the procedure to the step S02 and the operation of the steps S02 to S05 are repeated again. The comparison of the measured delay time and the reference delay time is then performed (step S06).

When the flag FLAG_A is determined as being set in the step S08, the drive capacity specified by the drive capacity specifying value D_{DRV2} at this moment is the optimum drive capacity with which the delay time across the characteristic measurement source lines 6C and 6D and the bridge interconnection 8 is close to the reference delay time. Then the drive capacity specifying value D_{DRV1}, which specifies the drive capacity of the output amplifiers 42, is set in accordance with the drive capacity specifying value D_{DRV2} (step S10). Most simply, the drive capacity specifying value D_{DRV1} is set to the same value as the drive capacity specifying value D_{DRV2}. This completes the optimization of the drive capacity of the output amplifiers 42 of the source drive circuit 22.

The above-described procedure allows appropriately setting the drive capacity of the output amplifiers 42 of the source drive circuit 22 in accordance with the characteristics of the liquid crystal display panel 1 (especially, the delay characteristics of the source lines 6).

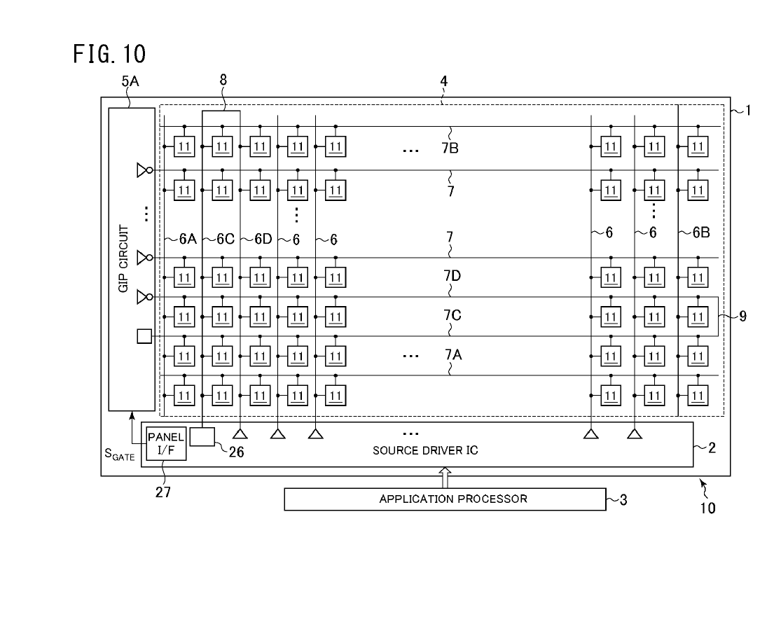

The drive capacity of a drive circuit which drives the gate lines 7 may be adjusted in a similar manner. When a gate driver IC 5A is used for driving the gate lines 7 instead of the GIP circuit 5 integrated on the liquid crystal display panel 1, for example, the drive capacity of a drive circuit which is integrated in the gate driver IC 5A to drive the gate lines 7 may be adjusted in accordance with the delay characteristics of the gate lines 7 as illustrated in FIG. 10. In this case, characteristic measurement gate lines 7C and 7D are provided as illustrated in FIG. 10. The characteristic measurement gate lines 7C and 7D are used to measure the characteristics of the liquid crystal display panel 1, particularly the delay characteristics of the gate lines 7. The characteristic measurement gate lines 7C and 7D have the same structure as the gate lines 7, and subpixels 11 are connected to the characteristic measurement gate lines 7C and 7D as is the case with the gate lines 7. Note that the subpixels 11 connected to the characteristic measurement gate lines 7C and 7D are not used for image display. The respective one ends of the characteristic measurement gate lines 7C and 7D are connected to the gate driver IC 5A, and the other ends of the characteristic measurement gate lines 7C and 7D located away from the gate driver IC 5A are connected via a bridge interconnection 9. When a signal is inputted to the end of the characteristic measurement gate line 7D connected to the gate driver IC 5A, a signal is outputted from the end of the characteristic measurement gate line 7C connected to the gate driver IC 5A. In the present embodiment, the characteristic measurement gate lines 7C and 7D are adjacent to each other, and accordingly the length of the bridge interconnection 9 is extremely small compared with the lengths of the characteristic measurement gate lines 7C and 7D. It should be noted that the bridge interconnection 9 does not need to be connected to the exact ends of the characteristic measurement gate lines 7C and 7D; the bridge interconnection 9 may be connected in the vicinity of the ends of the characteristic measurement gate lines 7C and 7D.

Although the characteristic measurement gate lines 7C and 7D are positioned adjacent to a dummy gate line 7A in FIG. 10, the characteristic measurement gate lines 7C and 7D may be provided at any position between the dummy gate lines 7A and 7B. It should be noted however that, if the characteristic measurement gate lines 7C and 7D, which are not used for image display, are disposed in the middle of the pixel arrangement region 4, a line may be observed at the position where the characteristic measurement gate lines 7C and 7D are disposed in an image displayed on the pixel arrangement region 4. Therefore, it is preferable that the characteristic measurement gate lines 7C and 7D are positioned adjacent to the dummy gate line 7A or 7B.

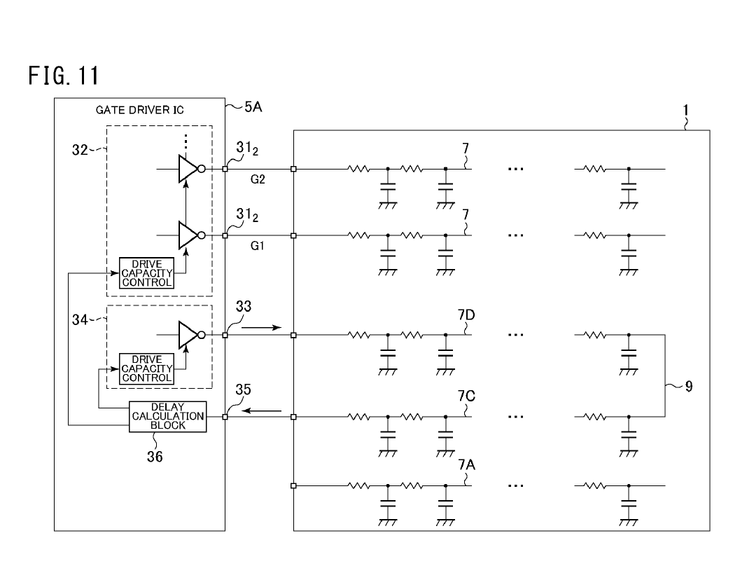

FIG. 11 conceptually illustrates an example of the configuration of the gate driver IC 5A adapted to adjust the drive capacity of the drive circuit which drives the gate lines 7. FIG. 11 only illustrates the configuration of a circuitry of the gate driver IC 5A for observing the waveform of the output signal outputted from the characteristic measurement gate line 7C and driving the gate lines 7.

The gate driver IC 5A includes gate outputs 31, a gate drive circuit 32, a measurement output pad 33, a drive circuit 34, a measurement input pad 35, and a delay calculating block 36. The gate outputs 31 are external connection pads connected to the gate lines 7. Note that subscripts may be attached to the numeral “31” when the gate outputs 31 are distinguished from each other. Although the two gate outputs 31₁ and 31₂ are illustrated in FIG. 11, a person skilled in the art would appreciate that a large number of gate outputs may be provided in an actual implementation. The gate drive circuit 32 drives the gate lines 7 connected to the gate outputs 31.

The measurement output pad 33 is an external connection pad connected to the characteristic measurement gate line 7D, and the drive circuit 34 drives the characteristic measurement gate line 7D connected to the measurement output pad 33. The drive circuit 34 is used to supply a step signal to the characteristic measurement gate line 7D in the measurement of the delay characteristics of the gate lines 7.

The measurement input pad 35 is an external connection pad connected to the characteristic measurement gate line 7C, and the delay calculating block 36 is used to observe an output signal outputted from the characteristic measurement gate line 7C connected to the measurement input pad 35. The delay calculating block 36 adjusts the drive capacity of the gate drive circuit 32 to drive the gate lines 7 in response to the waveform of the output signal outputted from the characteristic measurement gate line 7C.

Although the drive circuit 34 drives the characteristic measurement gate line 7D and the delay calculating block 36 observes the waveform of the output signal outputted from the characteristic measurement gate line 7C in the configuration illustrated in FIGS. 10 and 11, the drive circuit 34 may instead drive the characteristic measurement gate line 7C and the delay calculating block 36 observes the waveform of the output signal outputted from the characteristic measurement gate line 7D.

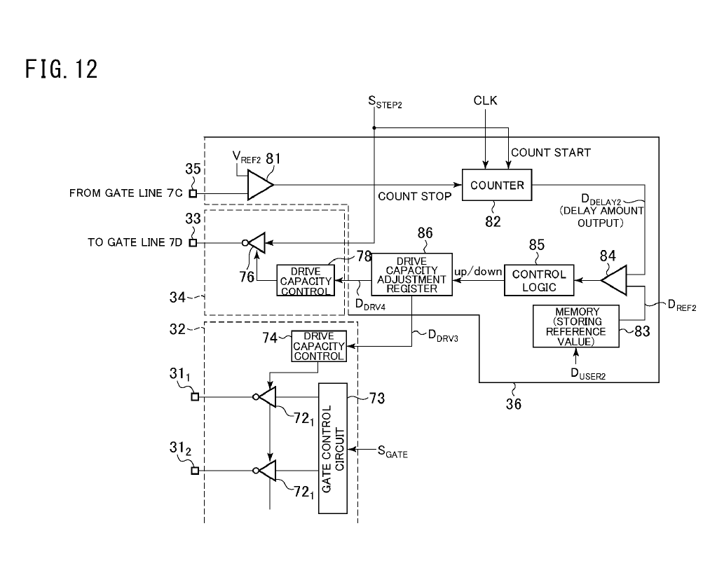

FIG. 12 is a block diagram illustrating an example of the configurations of the gate drive circuit 32, the drive circuit 34, and the delay calculating block 36. The gate drive circuit 32 includes output circuits 72, a gate control circuit 73, and a drive capacity control circuit 74. It should be noted that subscripts may be attached the numeral “72” when the output circuits 72 are distinguished from each other.

The output circuits 72, which are disposed to respectively accommodate the gate outputs 31, drive the gate lines connected to the corresponding gate outputs 31. In other words, the output circuits 72₁, 72₂, . . . drive the gate lines 7 connected to the gate outputs 31₁, 31₂, . . . , respectively. Each drive circuit 72 drives the gate line 7 connected to the corresponding gate output 31 to a predetermined negative voltage level GVSS when a control signal received from the gate control circuit 73 is negated, and drives the gate line 7 connected to the corresponding gate output 31 to a predetermined positive voltage level GVDD when the control signal received from the gate control circuit 73 is asserted. Here, the negative voltage level GVSS is a voltage level to which each gate line 7 is to be driven when the gate line 7 is not selected, and the positive voltage level GVDD is a voltage level to which each gate line 7 is to be driven when the gate line 7 is selected. The output circuit 72 is adapted to adjust the drive capacity thereof.

The gate control circuit 73 supplies a control signal to each of the output circuits 72 in response to gate control signals S_{GATE} supplied from the source driver IC 2. A shift register which performs a shift operation in response to the gate control signal S_{GATE} may be used as the gate control circuit 73, for example.

The drive capacity control circuit 74 controls the drive capacity of the output circuits 72 of the gate drive circuit 32. The control of the drive capacity by the drive capacity control circuit 74 is performed in accordance with a drive capacity specifying value D_{DRV3} supplied from the delay calculating block 36. Here, the drive capacity specifying value D_{DRV3} is a value which specifies the drive capacity of the output circuit 72.

The drive circuit 34 includes an output circuit 76 and a drive capacity control circuit 78. The output circuit 76 drives the characteristic measurement gate line 7D connected to the measurement output pad 33 in response to a step output signal S_{STEP2}. Here, the step output signal S_{STEP2} is a control signal which instructs to output a step signal to the characteristic measurement gate line 7D. The output circuit 76 drives the measurement output pad 33 to the predetermined negative voltage level GVSS when the step output signal S_{STEP2} is negated, and drives the measurement output pad 33 to the predetermined positive voltage level GVDD when the control signal received from the gate control circuit 73 is asserted. The output circuit 76, which has the same configuration as the output circuit 72 of the gate drive circuit 32, is adapted to adjust the drive capacity thereof.

The drive capacity control circuit 78 controls the drive capacity of the output circuit 76. The control of the drive capacity by the drive capacity control circuit 78 is performed in accordance with a drive capacity specifying value D_{DRV4} supplied from the delay calculating block 36. The drive capacity specifying value D_{DRV4} is a value which specifies the drive capacity of the output circuit 76.

The delay calculating block 36, which has the same configuration as the delay calculating block 26 of the source driver IC 2 (see FIG. 5), includes a comparator 81, a counter 82, a memory 83, a comparator 84, a control logic circuit 85, and a drive capacity adjustment register 86.

The comparator 81 receives the output signal outputted from the characteristic measurement gate line 7C via the measurement input pad 35, and compares the voltage level of the received output signal with the predetermined threshold level V_{REF2}. The output signal of the comparator 81 corresponds to the comparison result between the voltage level of the output signal outputted from the characteristic measurement gate line 7C and the threshold level V_{REF2}. In the present embodiment, the comparator 81 asserts the output signal thereof when the voltage level of the output signal outputted from the characteristic measurement gate line 7C is higher than the threshold level V_{REF2}.

The counter 82 counts a clock signal CLK (i.e. counts up a count value held by the counter 82 in synchronization with the clock signal CLK), and outputs the count value to one input of the comparator 84. The start of the counting operation of the counter 82 is controlled on the step output signal S_{STEP2}; the counter 82 starts the counting operation when the step output signal S_{STEP2} is asserted. On the other hand, the stop of the counting operation of the counter 82 is controlled on the output signal of the comparator 81; the counter 82 stops the counting operation when the output signal of the comparator 81 is asserted. Since the output signal of the comparator 81 is asserted when the voltage level of the output signal outputted from the characteristic measurement gate line 7C is higher than the threshold level V_{REF2} as described above, the counter 82 stops the counting operation when the voltage level of the output signal outputted from the characteristic measurement gate line 7C becomes higher than the threshold level V_{REF2}.

The count value at the moment when the counter 82 stops the counting operation corresponds to the delay time across the characteristic measurement gate lines 7C and 7D and the bridge interconnection 9. The count value at the moment when the counting operation is stopped increases when the delay time across the characteristic measurement gate lines 7C and 7D and the bridge interconnection 9 is increased, and the count value at the moment when the counting operation is stopped decreases when the delay time across the characteristic measurement gate lines 7C and 7D and the bridge interconnection 9 is decreased. The counter 82 supplies the count value at the moment when the counting operation is stopped to the comparator 84 as a delay amount output D_{DELAY2}.

The memory 83 holds a reference value D_{REF2} which corresponds to the reference delay time (desired delay time) of the characteristic measurement gate lines 7C and 7D and the bridge interconnection 9. The reference delay time held by the memory 83 is set by the user. More specifically, user setting data D_{USER2} describing the reference value D_{REF2} are externally (e.g. from the application processor 3) given to the source driver IC 2, and the reference value D_{REF2} described in the user setting data D_{USER2} is written into the memory 83.

The comparator 84 compares the delay amount output D_{DELAY2} received from the counter 82 with the reference value D_{REF2} received from the memory 83. The output signal of the comparator 84 corresponds to the comparison result between the delay amount output D_{DELAY2} and the reference value D_{REF2}.

The control logic circuit 85 adjusts register values held by the drive capacity adjustment register 86 in response to the output signal of the comparator 84. The register values held by the drive capacity adjustment register 86 include a drive capacity specifying value D_{DRV3} which specifies the drive capacity of the output circuit 72 of the gate drive circuit 32 and a drive capacity specifying value D_{DRV4} which specifies the drive capacity of the output circuit 76 of the gate drive circuit 34. The drive capacity specifying value D_{DRV3} is supplied to the drive capacity control circuit 74 of the gate drive circuit 32, and the drive capacity specifying value D_{DRV4} is supplied to the drive capacity control circuit 78 of the gate drive circuit 34.

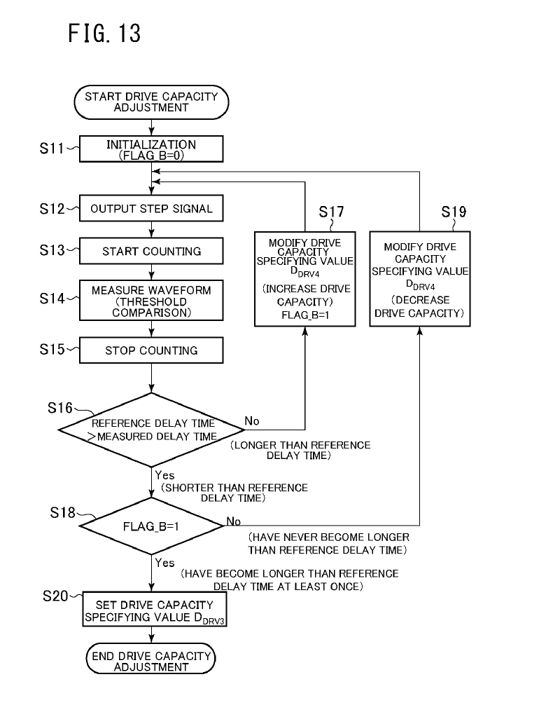

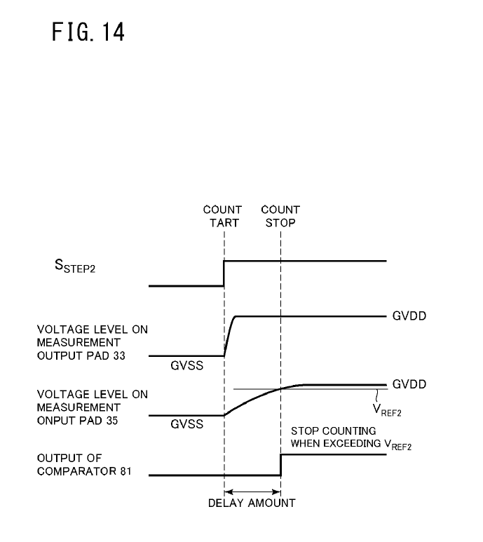

FIG. 13 is a flow chart illustrating the procedure for the delay calculating block 36 to adjust the drive capacity of the output circuit 72 of the gate drive circuit 32, and FIG. 14 is a timing chart illustrating the operation of the drive circuit 34 and the delay calculating block 36 according to the present embodiment.

The procedure for adjusting the drive capacity of the output circuit 72 of the gate drive circuit 32 is similar to the above-described procedure for adjusting the drive capacity of the output amplifiers 42 of the source drive circuit 22. More specifically, the procedure for adjusting the drive capacity of the output circuit 72 begins with initialization (step S11). In the initialization, the drive capacity specifying value D_{DRV4} held by the drive capacity adjustment register 86 of the delay calculating block 36 is first set to an initial value. This operation is equivalent to performing an initial setting of the drive capacity of the output circuit 76, since the drive capacity specifying value D_{DRV4} specifies the drive capacity of the output circuit 76 of the drive circuit 34. Furthermore, a flag FLAG_B of the control logic circuit 85 of the delay calculating block 36 is reset (that is, the flag FLAG_B is set to “0”), and the counter 82 is initialized. Here, the flag FLAG_B indicates whether the delay time across the characteristic measurement gate lines 7C and 7D and the bridge interconnection 9 have becomes longer than the reference delay time at least once in the following process. As described later, the flag FLAG_B is set (i.e. set to “1”) when the delay time across the characteristic measurement gate lines 7C and 7D and the bridge interconnection 9 has become longer than the reference delay time.

In addition, the characteristic measurement gate lines 7C and 7D are set to a predetermined initial voltage level. In the present embodiment, the characteristic measurement gate lines 7C and 7D are driven to the negative voltage level GVSS (i.e. the voltage level to which a non-selected gate line 7 is to be driven) by the output circuit 76.

Next, the positive voltage level GVDD (i.e. the voltage level to which a selected gate line 7 is selected) is outputted from the output circuit 76 of the drive circuit 34 to the measurement output pad 33, thereby driving the measurement output pad 33 to the positive voltage level GVDD (step S12). In other words, a step signal is outputted to the end of the characteristic measurement gate line 7D connected to the measurement output pad 23. More specifically, as illustrated in FIG. 14, the step output signal S_{STEP2} is asserted, and the positive voltage level GVDD is outputted from the output circuit 76 of the drive circuit 34 to the measurement output pad 33 in response to the assertion of the step output signal S_{STEP2}. As a result, the measurement output pad 33 is driven to the voltage level GVDD.

In this operation, the measurement output pad 33 is promptly driven to the voltage level GVDD, whereas the voltage level of the measurement input pad 35 is driven to the voltage level GVDD later than the measurement output pad 33 due to the delay across the characteristic measurement gate lines 7C and 7D and the bridge interconnection 9, as illustrated in FIG. 13. In the operation of steps S13 to S15 described below, the delay time across the characteristic measurement gate lines 7C and 7D and the bridge interconnection 9 is measured.

In detail, the counter 82 starts a counting operation in response to the assertion of the step output signal S_{STEP2} as illustrated in FIG. 13 (step S13).

In the meantime, the comparator 81 compares the voltage level on the measurement input pad 35 with the predetermined threshold level V_{REF2} (step S14). In other words, the comparator 81 receives the output signal outputted from the characteristic measurement gate line 7C through the measurement input pad 35, and compares the voltage level of the received output signal with the predetermined threshold level V_{REF2}. Here, the threshold level V_{REF2} is set to be lower than the voltage level GVDD to which the measurement output pad 33 is finally driven, and higher than the initial voltage level GVSS. As illustrated in FIG. 14, the output of the comparator 81 is asserted when the voltage level on the measurement input pad 35 is higher than the threshold level V_{REF2}.

When the output of the comparator 81 is asserted, the counter 82 stops the counting operation (step S15). The count value held by the counter 82 at this moment corresponds to the delay time across the characteristic measurement gate lines 7C and 7D and the bridge interconnection 9. The count value held by the counter 82 is outputted to the comparator 84 as the delay amount output D_{DELAY2}.

Furthermore, the value of the delay amount output D_{DELAY2} outputted from the counter 82 and the reference value D_{REF2} held by the memory 83 are compared by the comparator 84 (step S16). This operation is equivalent to the comparison of the measured delay time (the measured value of the delay time at the characteristic measurement gate lines 7C and 7D and the bridge interconnection 9) with the reference delay time.

When the measured delay time is longer than the reference delay time, i.e. when the value of the delay amount output D_{DELAY2} is larger than the reference value D_{REF2}, the flag FLAG_B is set (i.e. set to “1”) in the control logic circuit 85, and the drive capacity specifying value D_{DRV4} held by the drive capacity adjustment register 86 is modified by the control logic circuit 85 so that the drive capacity of the output circuit 76 of the drive circuit 34 is increased (step S17). Subsequently, the procedure returns to the step S12 and the operations of the steps S12 to S15 are repeated again. The comparison of the measured delay time with the reference delay time is then performed (step S16).

When determining that the measured delay time is shorter than the reference delay time at the step S16, i.e. when the value of the delay amount output D_{DELAY2} is smaller than the reference value D_{REF2}, the control logic circuit 85 determines whether the flag FLAG_B is set (i.e. whether the flag FLAG_B is set to “1”) (step S18). When the flag FLAG_B is not set, i.e. when delay time across the characteristic measurement gate lines 7C and 7D and the bridge interconnection 9 have never become longer than the reference delay time, the drive capacity specifying value D_{DRV4} held by the drive capacity adjustment register 86 is modified by the control logic circuit 85 so that the drive capacity of the output circuit 76 of the drive circuit 34 is reduced (step S19). Subsequently, the procedure returns to the step S12 and the operations of the steps S12 to S15 are repeated again. The comparison of the measured delay time with the reference delay time (step S16) is then performed.

When the flag FLAG_B is determined as being set at the step S18, the drive capacity specified by the drive capacity specifying value D_{DRV4} at this moment is an appropriate drive capacity with which the delay time across the characteristic measurement gate lines 7C and 7D and the bridge interconnection 9 is close to the reference delay time. Accordingly, the drive capacity specifying value D_{DRV3}, which specifies the drive capacity of the output circuit 72, is set in accordance with the drive capacity specifying value D_{DRV4} (step S20). Most simply, the drive capacity specifying value D_{DRV3} is set to the same value as the drive capacity specifying value D_{DRV4}. This completes optimization of the drive capacity of the output circuit 72 of the gate drive circuit 32.

The above-described procedure allows appropriately setting the drive capacity of the output circuit 72 of the gate drive circuit 32 in accordance with the characteristics of the liquid crystal display panel 1 (especially, the delay characteristics of the gate lines 7).

Although the embodiments described-above recite that the dummy source lines 6A and 6B and the characteristic measurement source lines 6C and 6D are provided in the pixel arrangement region 4, the dummy source lines 6A and 6B do not necessarily need to be provided; however, the configuration in which the dummy source lines 6A and 6B and the characteristic measurement source lines 6C and 6D are provided is more preferable since the characteristics of the characteristic measurement source lines 6C and 6D may differ from the characteristics of the source lines 6 in the configuration in which the dummy source lines 6A and 6B are not provided.

Similarly, the dummy gate lines 7A and 7B do not necessarily need to be provided; however, the configuration in which the dummy gate lines 7A and 7B and the characteristic measurement gate lines 7C and 7D are provided is more preferable since the characteristics of the characteristic measurement gate lines 7C and 7D may differ from the characteristics of the gate lines 7 in the configuration where the dummy gate lines 7A and 7B are not provided.

### Second Embodiment

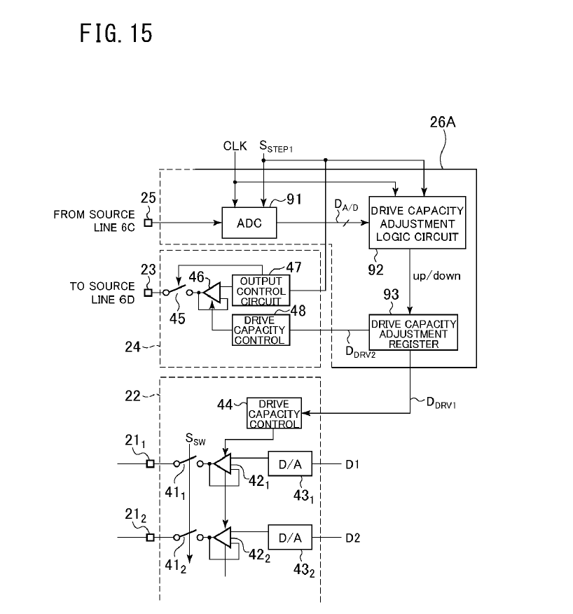

FIG. 15 is a block diagram illustrating an example of the configuration of a source driver IC 2, more specifically the configurations of a source drive circuit 22, a drive circuit 24 and a delay calculating block 26A according to a second embodiment of the present invention. Although the configurations of the source drive circuit 22 and the drive circuit 24 in the second embodiment are the same as those in the first embodiment, the delay calculating block 26A having a configuration different from the delay calculating block 26 of the first embodiment is used instead in the second embodiment. The delay calculating block 26A used in the second embodiment is configured to observe the waveform of the output signal outputted from the characteristic measurement source line 6C by using an A/D converter.

More specifically, the delay calculating block 26A includes an A/D converter 91, a drive capacity adjustment logic circuit 92, and a drive capacity adjustment register 93. The input of the A/D converter 91 is connected to the measurement input pad 25, and the output signal outputted from the characteristic measurement source line 6C is inputted to the A/D converter 91. The A/D converter 91, when a step output signal S_{STEP1} is asserted, performs analog-digital conversion on the output signal outputted from the characteristic measurement source line 6C in synchronization with a clock signal CLK to generate digital waveform data D_{A/D}. The digital waveform data D_{A/D} are a set of data indicating the voltage level of the output signal outputted from the characteristic measurement source line 6C at each time, i.e. time-dependent data indicating the waveform of the output signal. The digital waveform data D_{A/D} reflect the delay characteristics of the source lines 6. The A/D converter 91 updates the digital waveform data D_{A/D} in each clock cycle. In the present embodiment, one cycle period of a clock signal CLK is defined as one clock cycle.

The drive capacity adjustment logic circuit 92 adjusts register values held by the drive capacity adjustment register 93 in response to the digital waveform data D_{A/D}. The register values held by the drive capacity adjustment register 93 include a drive capacity specifying value D_{DRV1} which specifies the drive capacity of the output amplifiers 42 of the source drive circuit 22, and a drive capacity specifying value D_{DRV2} which specifies the drive capacity of the output amplifier 46 of the drive circuit 24. Since the digital waveform data D_{A/D} are time-dependent data indicating the waveform of the output signal outputted from the characteristic measurement source line 6C as described above, the drive capacity adjustment logic circuit 92 has the function of adjusting the drive capacity specifying values D_{DRv1} and D_{DRV2} in accordance with the waveform of the output signal outputted from the characteristic measurement source line 6C, that is, in accordance with the delay characteristics of the source lines 6. The drive capacity specifying value D_{DRV1} is supplied to the drive capacity control circuit 44 of the source drive circuit 22 and the drive capacity specifying value D_{DRV2} is supplied to the drive capacity control circuit 48 of the drive circuit 24.

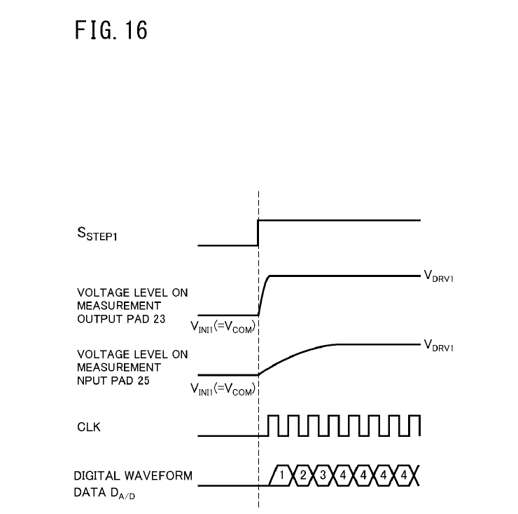

FIG. 16 is a timing chart illustrating the operation of the drive circuit 24 and the delay calculating block 26A. In the initial state, the characteristic measurement source lines 6C and 6D are set to a predetermined initial voltage level V_{INI1} (most typically, the common level V_{COM} (i.e. the voltage level on the counter electrode 14)).

Additionally, the drive capacity specifying value D_{DRV2} held by the drive capacity adjustment register 93 of the delay calculating block 26A is set to an initial value. Since the drive capacity specifying value D_{DRV2} specifies the drive capacity of the output amplifier 46 of the drive circuit 24, this operation is equivalent to performing an initial setting to the drive capacity of the output amplifier 46.

In the measurement of the delay characteristics of the source lines 6, the step output signal S_{STEP1} is first asserted. After the step output signal S_{STEP1} is asserted, the same voltage as the drive voltage V_{DRV1} is supplied from the output control circuit 47 of the drive circuit 24 to the input of the output amplifier 46, and the output switch 45 of the drive circuit 24 is turned on. As a result, the drive voltage V_{DRV1} is outputted from the output amplifier 46 to the measurement output pad 23 to drive the measurement output pad 23 to the voltage level V_{DRV1}.

In this operation, the measurement output pad 23 is promptly driven to the voltage level V_{DRV1}, whereas the voltage level of the measurement input pad 25 is driven to the voltage level V_{DRV1} later than the measurement output pad 23 due to the delay across the characteristic measurement source lines 6C and 6D and the bridge interconnection 8.

In the meantime, the A/D converter 91 of the delay calculating block 26A performs analog-digital conversion on the output signal outputted from the characteristic measurement source line 6C in synchronization with the clock signal CLK after the step output signal S_{STEP1} is asserted, and successively outputs the digital waveform data D_{A/D}, which are a set of data indicating the voltage level of the output signal outputted from the characteristic measurement source line 6C at each time. The digital waveform data D_{A/D} are time-dependent data indicating the waveform of the output signal outputted from the characteristic measurement source line 6C.

The drive capacity adjustment logic circuit 92 of the delay calculating block 26A calculates the drive capacity specifying value D_{DRV1} which specifies the drive capacity of the output amplifiers 42 of the source drive circuit 22 in accordance with the digital waveform data D_{A/D}. More specifically, the drive capacity adjustment logic circuit 92, when determining from the digital waveform data D_{A/D} that the drive capacity specified by the drive capacity specifying value D_{DRV2} is in an appropriate range, calculates the drive capacity specifying value D_{DRV1} to specify the same drive capacity as that specified by the drive capacity specifying value D_{DRV2}. In this case, the same value as the drive capacity specifying value D_{DRV2} may be set to the drive capacity specifying value D_{DRV1} for example. When determining from the digital waveform data D_{A/D} that the drive capacity specified by the drive capacity specifying value D_{DRV2} is not sufficient, on the other hand, the drive capacity adjustment logic circuit 92 calculates the drive capacity specifying value D_{DRV1} to specify a drive capacity higher than the drive capacity specified by the drive capacity specifying value D_{DRV2}. When determining from the digital waveform data D_{A/D} that the drive capacity specified by the drive capacity specifying value D_{DRV2} is excessive, the drive capacity adjustment logic circuit 92 calculates the drive capacity specifying value D_{DRV1} to specify a drive capacity lower than the drive capacity specified by the drive capacity specifying value D_{DRV2}.

The above-described operation allows appropriately setting the drive capacity of the output amplifiers 42 of the source drive circuit 22 in accordance with the delay characteristics of the source lines 6.

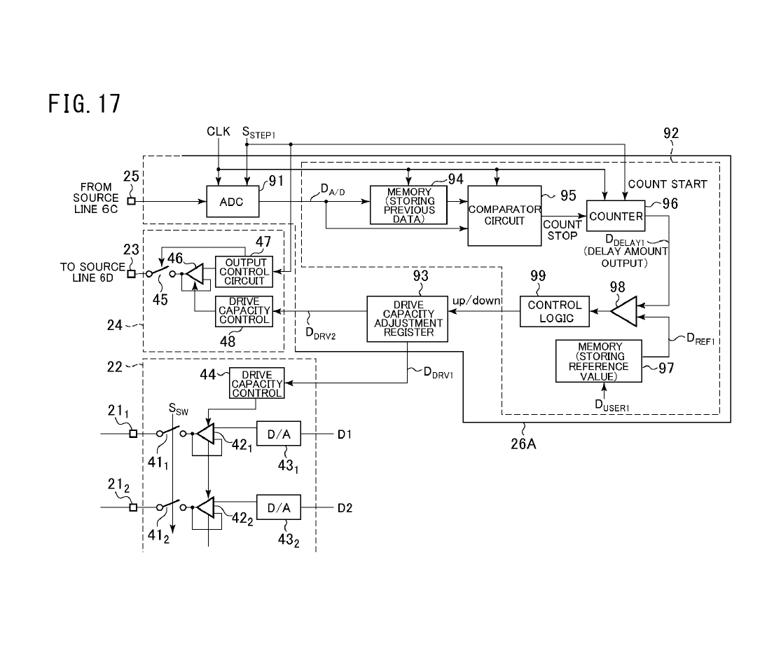

In one embodiment, the delay time across the characteristic measurement source lines 6C and 6D and the bridge interconnection 8 may be measured from the digital waveform data D_{A/D} generated by the A/D converter 91 to adjust the drive capacity of the output amplifiers 42 of the source drive circuit 22 in accordance with the measured delay time, as is the case with the first embodiment. FIG. 17 is a block diagram specifically illustrating the configuration of the drive capacity adjustment logic circuit 92 of the delay calculating block 26A for performing such an operation.

The drive capacity adjustment logic circuit 92 includes a memory 94, a comparator circuit 95, a counter 96, a memory 97, a comparator 98 and a control logic circuit 99.

The memory 94 operates as a delay section which temporarily holds the digital waveform data D_{A/D} to provide a delay for the digital waveform data D_{A/D} held thereby by one clock cycle (one cycle period of the clock signal CLK in the present embodiment).

The comparator circuit 95 compares the value of the digital waveform data D_{A/D} directly received from the A/D converter 91 with the value of the digital waveform data D_{A/D} delayed by one clock cycle by the memory 94. The comparator circuit 95 asserts the output signal when the value of the digital waveform data D_{A/D} directly received from the A/D converter 91 is equal to the value of the digital waveform data D_{A/D} received from the memory 94, and negates the output signal when the value of the digital waveform data D_{A/D} directly received from the A/D converter 91 is different from the value of the digital waveform data D_{A/D} received from the memory 94. The output signal of the comparator circuit 95 corresponds to the comparison result between the value of the digital waveform data D_{A/D} directly received from the A/D converter 91 and the value of the digital waveform data D_{A/D} received from the memory 94.

The counter 96 counts the clock signal CLK (i.e. counts up the count value held by the counter 96 in synchronization with the clock signal CLK) to output the count value to one input of the comparator 98. The start of the counting operation of the counter 96 is controlled by the step output signal S_{STEP1}; the counter 96 starts the counting operation when the step output signal S_{STEP1} is asserted. On the other hand, the stop of the counting operation of the counter 96 is controlled by an output signal of the comparator circuit 95; the counter 96 stops the counting operation when the output signal of the comparator circuit 95 is asserted. Since the output signal of the comparator circuit 95 is asserted when the value of the digital waveform data D_{A/D} directly received from the A/D converter 91 agrees with the value of the digital waveform data D_{A/D} received from the memory 94, as described above, the counter 96 stops the counting operation when the change in the voltage level of the output signal outputted from the characteristic measurement source line 6C has become small.

The count value at the moment when the counter 96 stops the counting operation corresponds to the delay time across the characteristic measurement source lines 6C and 6D and the bridge interconnection 8. The count value at the moment when the counting operation is stopped increases when the delay time across the characteristic measurement source lines 6C and 6D and the bridge interconnection 8 is increased, and the count value at the moment when the counting operation is stopped decreases when the delay time across the characteristic measurement source lines 6C and 6D and the bridge interconnection 8 is decreased. The counter 96 supplies the count value at the moment when the counting operation is stopped to the comparator 98 as the delay amount output D_{DELAY1}.

The memory 97 holds a reference value D_{REF1} which corresponds to a reference delay time (desired delay time) across the characteristic measurement source lines 6C and 6D and the bridge interconnection 8. The reference delay time held by the memory 97 is set by the user. More specifically, user setting data D_{USER1} describing the reference value D_{REF1} is externally fed to the source driver IC 2 (e.g. from the application processor 3), and the reference value D_{REF1} described in the user setting data D_{USER1} is written into the memory 97.

The comparator 98 compares the delay amount output D_{DELAY1} received from the counter 96 with the reference value D_{REF1} received from the memory 97. The output signal from the comparator 98 corresponds to the comparison result between the delay amount output D_{DELAY1} and the reference value D_{REF1}.

The control logic circuit 99 adjusts the drive capacity specifying values D_{DRV1} and D_{DRV2} held by the drive capacity adjustment register 93 in response to the output signal of the comparator 98. As described above, the drive capacity specifying values D_{DRV1} specifies the drive capacity of the output amplifiers 42 of the source drive circuit 22, and the drive capacity specifying values D_{DRV2} specifies the drive capacity of the output amplifier 46 of the source drive circuit 24.

In the following, a description is given of on an exemplary procedure for adjusting the drive capacity of the output amplifiers 42 by using the drive capacity adjustment logic circuit 92 having the configuration illustrated in FIG. 17.

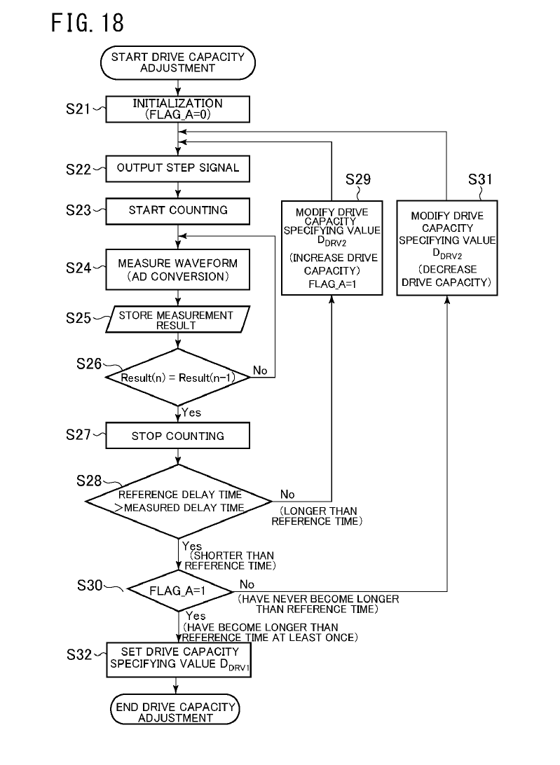

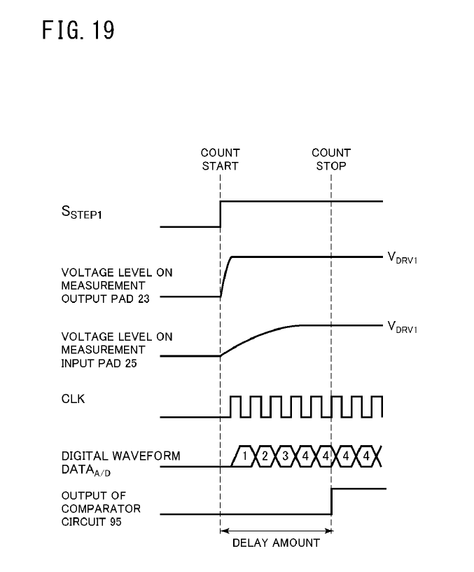

FIG. 18 is a flow chart illustrating the procedure for adjusting the drive capacity of the output amplifiers 42 of the source drive circuit 22 by using the drive capacity adjustment logic circuit 92 having the configuration illustrated in FIG. 17, and FIG. 19 is a timing chart illustrating the operation of the drive circuit 24 and the delay calculating block 26A.

The procedure for adjusting the drive capacity of the output amplifiers 42 begins with initialization (step S21). In the initialization, the drive capacity specifying value D_{DRV2} held by the drive capacity adjustment register 93 of the delay calculating block 26A is first set to an initial value. This operation is equivalent to performing an initial setting to the drive capacity of the output amplifier 46, since the drive capacity specifying value D_{DRV2} specifies the drive capacity of the output amplifier 46 of the drive circuit 24. Furthermore, a flag FLAG_A of the control logic circuit 99 of the delay calculating block 26 is reset (the flag FLAG_A is set to “0”), and the counter 96 is initialized. Here, the flag FLAG_A indicates whether the delay time across the characteristic measurement source lines 6C and 6D and the bridge interconnection 8 have becomes later than the reference delay time at least once in the following process. As described later, the flag FLAG_A is set (i.e. set to “1”) when the delay time across the characteristic measurement source lines 6C and 6D and the bridge interconnection 8 has become later than the reference delay time.

In addition, the characteristic measurement source lines 6C and 6D are set to the predetermined initial voltage level V_{INI1} (most typically, the common level V_{COM} (i.e. the voltage level on the counter electrode 14)). The setting of the characteristic measurement source lines 6C and 6D to the initial voltage level V_{INI1} may be achieved by short-circuiting the measurement output pad 23 and the measurement input pad 25 to a node having the initial voltage level V_{INI1} through a switch (not shown), for example.

Subsequently, the drive voltage V_{DRV1} is outputted from the output amplifier 46 of the drive circuit 24 to the measurement output pad 23, thereby driving the measurement output pad 23 to the voltage level V_{DRV1} (step S22). In other words, a step signal is outputted to the end of the characteristic measurement source line 6D connected to the measurement output pad 23. More specifically, when the step output signal S_{STEP1} is asserted, the same voltage as the drive voltage V_{DRV1} is supplied from the output control circuit 47 of the drive circuit 24 to the input of the output amplifier 46, and the output switch 45 of the drive circuit 24 is turned on, as illustrated in FIG. 19. As a result, the drive voltage V_{DRV1} is outputted from the output amplifier 46 to the measurement output pad 23 and the measurement output pad 23 is driven to the voltage level V_{DRV1}.

In this operation, the measurement output pad 23 is promptly driven to the voltage level V_{DRV1} whereas the voltage level of the measurement input pad 25 is driven to the voltage level V_{DRV1} later than the measurement output pad 23 due to the delay across the characteristic measurement source lines 6C and 6D and the bridge interconnection 8. In the operation of steps S23 to S27 described below, the delay time across the characteristic measurement source lines 6C and 6D and the bridge interconnection 8 is measured.

More specifically, the counter 96 starts the counting operation in response to assertion of the step output signal S_{STEP1} as illustrated in FIG. 18 (step S23).

In the meantime, the A/D converter 91 performs analog-digital conversion on the output signal outputted from the characteristic measurement source line 6C in synchronization with the clock signal CLK and thereby generates the digital waveform data D_{A/D} so as to indicate a value which corresponds to the voltage level of the output signal (step S24). The generated digital waveform data D_{A/D} are stored in the memory 94 in synchronization with the clock signal CLK (step S25).

The comparator circuit 95 compares the value of the digital waveform data D_{A/D} outputted from the A/D converter 91 with the value of the digital waveform data D_{A/D} of the previous clock cycle outputted from the memory 94 (step S26). As illustrated in FIG. 19, the output signal of the comparator circuit 95 is asserted when the value of the digital waveform data D_{A/D} outputted from the A/D converter 91 is equal to the value of the digital waveform data D_{A/D} of the previous clock cycle outputted from the memory 94. The operation of the steps S24 to S26 is repeated until the output signal of the comparator circuit 95 is asserted.

When the output signal of the comparator circuit 95 is asserted, the counter 96 stops the counting operation (step S27). The count value held by the counter 96 at this moment corresponds to the delay time across the characteristic measurement source lines 6C and 6D and the bridge interconnection 8. The count value held by the counter 96 is outputted to the comparator 98 as the delay output D_{DELAY1}.

Furthermore, the comparator 98 compares the value of the delay output D_{DELAY1} outputted from the counter 96 with the reference value D_{REF1} held by the memory 97 (step S28). This operation is equivalent to the comparison of the measured delay time (the measured value of the delay time across the characteristic measurement source lines 6C and 6D and the bridge interconnection 8) with the reference delay time.

When the measured delay time is longer than the reference delay time, i.e. when the value of the delay amount output D_{DELAY1} is larger than the reference value D_{REF1}, the flag FLAG_A is set (i.e. set to “1”) in the control logic circuit 99, and the drive capacity specifying value D_{DRV2} held by the drive capacity adjustment register 93 is modified by the control logic circuit 99 so that the drive capacity of the output amplifier 46 of the drive circuit 24 is increased (step S29). Subsequently, the procedure returns to step S22 and the operations of the steps S22 to S27 are repeated again. The measured delay time is then compared with the reference delay time (step S28).

When determining that the measured delay time is shorter than the reference delay time, i.e. when the value of the delay amount output D_{DELAY1} is smaller than the reference value D_{REF1} at step S28, the control logic circuit 99 further determines whether the flag FLAG_A is set (i.e. whether the flag FLAG_A is set to “1”) (step S30). When the flag FLAG_A is not set, i.e. when the delay time across the characteristic measurement source lines 6C and 6D and the bridge interconnection 8 has never become longer than the reference delay time, the drive capacity specifying value D_{DRV2} held by the drive capacity adjustment register 93 is modified by the control logic circuit 99 so that the drive capacity of the output amplifier 46 of the drive circuit 24 is decreased (step S31). Subsequently, the procedure returns to step S22 and the operations of steps S22 to S27 are repeated again and the measured delay time is then compared with the reference delay time (step S28).

When the flag FLAG_A is determined as being set at step S30, the drive capacity specified by the drive capacity specifying value D_{DRV2} at this moment is an appropriate drive capacity with which the delay time across the characteristic measurement source lines 6C and 6D and the bridge interconnection 8 becomes close to the reference delay time. Then the drive capacity specifying value D_{DRV1} which specifies the drive capacity of the output amplifiers 42 is set in accordance with the drive capacity specifying value D_{DRV2} (step S32). Most simply, the drive capacity specifying value D_{DRV1} is set to the same value as the drive capacity specifying value D_{DRV2}. This completes optimization of the drive capacity of the output amplifiers 42 of the source drive circuit 22.

The above-described procedure allows appropriately setting the drive capacity of the output amplifiers 42 of the source drive circuit 22 in accordance with the delay characteristics of the source lines 6.

### Third Embodiment

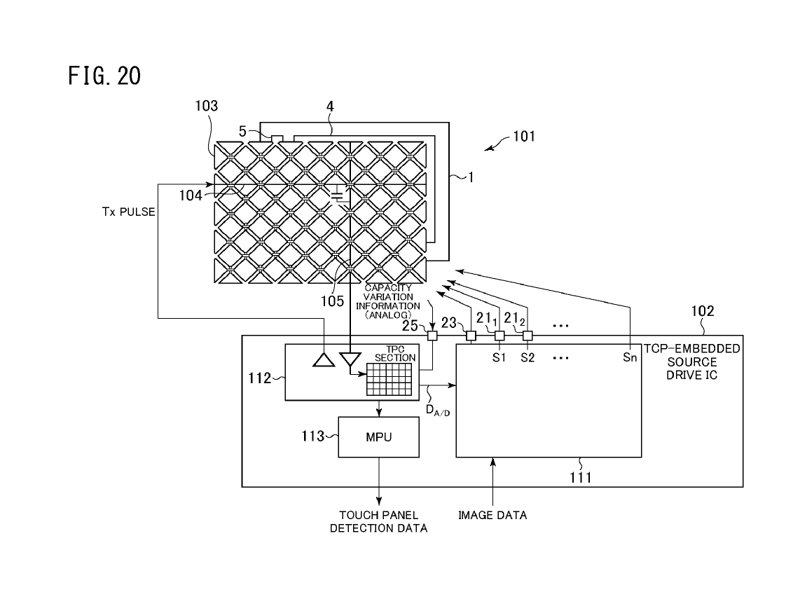

FIG. 20 is a block diagram illustrating an exemplary entire configuration of a liquid crystal display device 101 according to a third embodiment of the present invention. In the third embodiment, the liquid crystal display device 101 further includes a touch panel 103 in addition to the liquid crystal display panel 1. The touch panel 103 is disposed adjacent to the liquid crystal display panel 1. Additionally, a source driver IC is provided with the function of performing processing for driving of the touch panel 103 and detection of contact onto the touch panel 103. The source driver IC used in the third embodiment is referred to as a TPC-embedded source driver IC 102, hereinafter. Although FIG. 20 illustrates the configuration in which the GIP circuit 5 is integrated in the liquid crystal display panel 1, a gate driver IC 5A may be disposed on the liquid crystal display panel 1 as in the case with the second embodiment.

The TPC-embedded source driver IC 102 according to the present embodiment includes a source driver section 111, a touch panel controller (TPC) section 112, and a MPU (micro processing unit) 113. It should be noted that the source driver section 111, the touch panel controller section 112, and the MPU 113 are integrated monolithically, i.e. in a single semiconductor chip in the present embodiment.

The source driver section 111 includes a circuitry for driving source lines 6 of the liquid crystal display panel 1. The touch panel controller section 112 includes a circuitry for driving the touch panel 103 and obtaining digital information illustrating an electrical state of the touch panel 103. In the present embodiment, the touch panel controller section 112 has the function of driving horizontal electrode patterns 104 of the touch panel 103, and detecting the capacity between each combination of a horizontal electrode pattern 104 and a vertical electrode pattern 105. Here, the horizontal electrode patterns 104 are extended in the horizontal direction of the touch panel 103, and the vertical electrode patterns 105 are extended in the vertical direction of the touch panel 103.

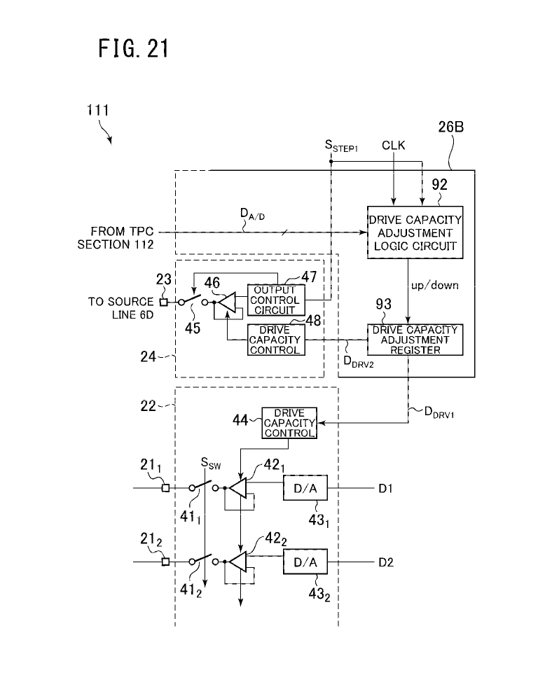

FIG. 21 is a block diagram illustrating an exemplary configuration of the source driver section 111. The source driver section 111 is configured similarly to the source driver IC 2 of the second embodiment illustrated in FIG. 15. The difference is that no A/D converter is integrated in the delay calculating block 26B. As described later, an A/D converter integrated in the touch panel controller section 112 is used for generation of the digital waveform data D_{A/D}, which indicates the waveform of the output signal inputted to the measurement input pad 25 from the characteristic measurement source line 6C.

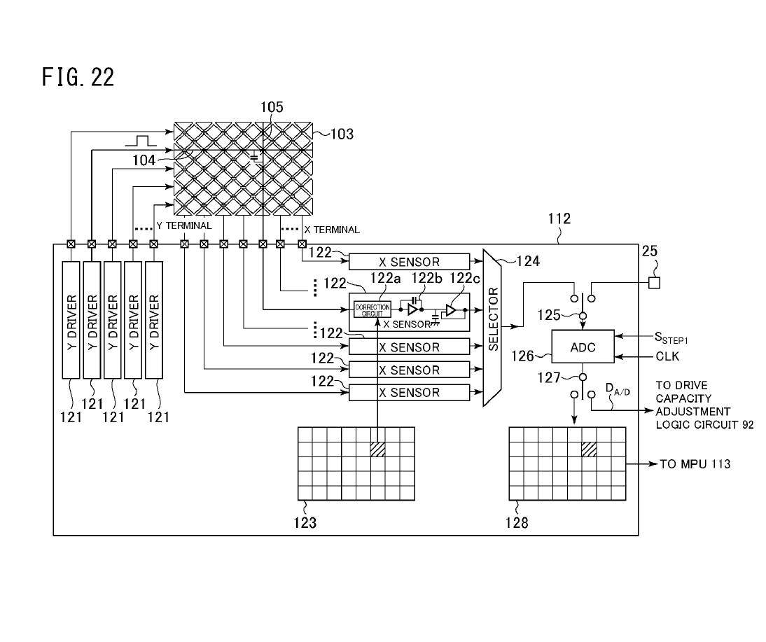

FIG. 22 is a block diagram illustrating details of the configuration of the touch panel controller section 112. The touch panel controller section 112 includes Y drivers 121, X sensors 122, a calibration RAM (random access memory) 123, a selector 124, a switch 125, an A/D converter 126, a switch 127 and a scan RAM 128.

The Y drivers 121 are connected to the horizontal electrode patterns 104 to supply drive pulses to the connected horizontal electrode patterns 104. The Y drivers 121 are sequentially operated, thereby supplying drive pulses sequentially to the horizontal electrode patterns 104.

The X sensors 122 are connected to the vertical electrode patterns 105 to receive detection signals having signal levels corresponding to the voltage levels on the connected vertical electrode patterns 105. The voltage level on each vertical electrode pattern 105 when a drive pulse is supplied to a horizontal electrode pattern 104 depends on the capacity between that horizontal electrode pattern 104 and each vertical electrode pattern 105. Therefore, it is possible to obtain information of the capacity (capacity information) between a horizontal electrode pattern 104 and a vertical electrode pattern 105 by capturing a detection signal with a signal level corresponding to the voltage level on the vertical electrode patterns 105.

More specifically, the X sensors 122 each include a correction circuit 122a, an integration circuit 122b, and a sample-and-hold circuit 122c. The correction circuit 122a performs a correction on a received detection signal with calibration data stored in the calibration RAM 123. The integration circuit 122b integrates the output signal of the correction circuit 122a. The sample-and-hold circuit 122c samples and holds the voltage generated on the output of the integration circuit 122b.

The calibration RAM 123 stores the calibration data used for the correction in the correction circuit 122a for each of the combinations of the horizontal electrode pattern 104 and the vertical electrode patterns 105.

The selector 124 selects the output signals of the X sensors 122 to output the selected output signal.

The A/D converter 126 has two functions. First, the A/D converter 126 performs analog-digital conversion on the output signal of the X sensor 122 selected by the selector 124. Since the output signal of an X sensor 122 is an analog signal indicating the electrical state of the touch panel 103, this implies that the A/D converter 126 has the function of performing analog-digital conversion on the analog signal indicating the electrical state of the touch panel 103 to generate digital data indicating the electrical state of the touch panel 103. Second, the A/D converter 126 generates the digital waveform data D_{A/D} indicating the waveform of the output signal inputted to the measurement input pad 25 from the characteristic measurement source line 6C as is the case with the second embodiment. The switches 125 and 127 switch connection destinations of the input and output of the A/D converter 126 in order to switch the A/D converter 126 between the above-mentioned two operations. The switch 125 connects selected one of the output of the selector 124 and the measurement input pad 25 to the input of the A/D converter 126. The switch 127 connects selected the output of the A/D converter 126 to selected one of the scan RAM 128 and the drive capacity adjustment logic circuit 92 of the source driver section 111.

In general, the circuit size of an A/D converter is large and this implies that integration of an A/D converter increases the area of a semiconductor chip. In the present embodiment, the A/D converter 126 is used both for the generation of digital information indicating the electrical state of the touch panel 103 and the generation of the digital waveform data D_{A/D} indicating the waveform of the output signal inputted to the measurement input pad 25 from the characteristic measurement source line 6C, and this effectively provides multi-functionality for the TPC-embedded source driver IC 102 with a decreased circuit size.

The scan RAM 128 stores digital data outputted from the A/D converter 126 as digital capacity information which are digital data indicating the capacities between the horizontal electrode patterns 104 and the vertical electrode patterns 105.

In the present embodiment, the touch panel controller section 112 obtains digital capacity information between each of the combinations of the horizontal electrode patterns 104 and the vertical electrode patterns 105 through the following operation: A drive pulse is supplied to a selected horizontal electrode pattern 104 from the Y driver 121 connected thereto. When the drive pulse is supplied, the capacities between the selected horizontal electrode pattern 104 and the respective vertical electrode patterns 105 are charged, generating voltages on the respective vertical electrode patterns 105. As a result, a detection signal with the signal level which corresponds to the voltage of each vertical electrode pattern 105 is received by the correction circuit 122a of each X sensor 122. The detection signal received by the correction circuit 122a is corrected with the calibration data stored in the calibration RAM 123, and sent to the integration circuit 122b. The supply of a drive pulse and the reception of detection signals into the X sensors 122 are performed a plurality of times, and the voltages corresponding to the capacities between the horizontal electrode pattern 104 and the vertical electrode pattern 105 are generated on the outputs of the integration circuits 122b. The voltages generated on the output of the integration circuits 122b are received by the sample-and-hold circuits 122c. Furthermore, the output signals of the X sensors 122 (i.e. the output signals of the sample-and-hold circuits 122c) are sequentially selected by the selector 124, and the selected output signal of the X sensor 122 is supplied to the A/D converter 126. The A/D converter 126 performs analog-digital conversion on the selected output signal of the X sensor 122. The digital data obtained through the analog-digital conversion is written into the scan RAM 128 as digital capacity information. The digital capacity information written into the scan RAM 128 is serially read out by the MPU 113 and used for the processing at the MPU 113.

The MPU 113 has the function of obtaining digital information indicating the electrical state of the touch panel 103 from the touch panel controller section 112 and detecting a contact of an object with the touch panel 103 from the digital information. In the present embodiment, the MPU 113 reads out the digital capacity information from the scan RAM 128 of the touch panel controller section 112, and calculates coordinates of the touch panel 103 at which an object (e.g. a finger of a user) is placed into contact with the touch panel 103. Furthermore, the MPU 113 detects a touch operation onto the touch panel 103 (i.e. an operation performed onto the touch panel 103 by a user) from the calculated coordinates of the touch panel 103, and generates touch panel detection data indicating the detected touch operation.

In the present embodiment, the A/D converter 126 is used both for the generation of the digital waveform data D_{A/D} in the adjustment of the drive capacity of the output amplifiers 42 of the source drive circuit 22, and the generation of the digital data indicating the electrical state of the touch panel 103 through analog-digital conversion on analog signals indicating the electrical state of the touch panel 103.

More specifically, in adjusting the drive capacity of the output amplifiers 42 of the source drive circuit 22, the measurement input pad 25 is connected to the input of the A/D converter 126 by the switch 125, and the output of the A/D converter 126 is connected to the input of the drive capacity adjustment logic circuit 92 of the delay calculating block 26B by the switch 127.

Furthermore, the characteristic measurement source lines 6C and 6D are set to the predetermined initial voltage level V_{INI1} (most typically, the common level V_{COM} (i.e. the voltage level on the counter electrode 14)), and the drive capacity specifying value D_{DRV2} held by the drive capacity adjustment register 93 of the delay calculating block 26B is set to an initial value. Since the drive capacity specifying value D_{DRV2} specifies the drive capacity of the output amplifier 46 of the drive circuit 24, this operation is equivalent to performing an initial setting to the drive capacity of the output amplifier 46.

Furthermore, the delay characteristics of the source lines 6 are measured. More specifically, the step output signal S_{STEP1} is first asserted. When the step output signal S_{STEP1} is asserted, the same voltage as the drive voltage V_{DRV1} is supplied from the output control circuit 47 of the drive circuit 24 to the input of the output amplifier 46, and the output switch 45 of the drive circuit 24 is turned on. As a result, the drive voltage V_{DRV1} is outputted from the output amplifier 46 to the measurement output pad 23, and the measurement output pad 23 is driven to the voltage level V_{DRv1}.

In this operation, the measurement output pad 23 is promptly driven to the voltage level V_{DRV1}, whereas the voltage level on the measurement input pad 25 is driven to the voltage level V_{DRV1} later than the measurement output pad 23 due to the delay across the characteristic measurement source lines 6C and 6D and the bridge interconnection 8.

In the meantime, after the step output signal S_{STEP1} is asserted, the A/D converter 126 performs analog-digital conversion for the output signal outputted from the characteristic measurement source line 6C in synchronization with the clock signal CLK, and sequentially outputs the digital waveform data D_{A/D} which is a set of data indicating the voltage level of the output signal outputted from the characteristic measurement source line 6C at each time. The digital waveform data D_{A/D} is time-dependent data indicating the waveform of the output signal outputted from the characteristic measurement source line 6C.

The drive capacity adjustment logic circuit 92 of the delay calculating block 26B calculates the drive capacity specifying value D_{DRV1} for specifying the drive capacity of the output amplifiers 42 of the source drive circuit 22 in accordance with the digital waveform data D_{A/D} generated by the A/D converter 126. More specifically, when determining from the digital waveform data D_{A/D} that the drive capacity specified by the drive capacity specifying value D_{DRV2} is in an appropriate range, the drive capacity adjustment logic circuit 92 calculates the drive capacity specifying value D_{DRV1} so that the same drive capacity as the drive capacity specifying by the drive capacity specifying value D_{DRV2} is specified. In this case, the same value as the drive capacity specifying value D_{DRV2} may be set to the drive capacity specifying value D_{DRV1}, for example. When determining from the digital waveform data D_{A/D} that the drive capacity specified by the drive capacity specifying value D_{DRV2} is not sufficient, the drive capacity adjustment logic circuit 92 calculates the drive capacity specifying value D_{DRV1} to specify a drive capacity higher than the drive capacity specified by the drive capacity specifying value D_{DRV2}. When determining from the digital waveform data D_{A/D} that the drive capacity specified by the drive capacity specifying value D_{DRV2} is excessive, the drive capacity adjustment logic circuit 92 calculates the drive capacity specifying value D_{DRV1} to specify a drive capacity lower than the drive capacity specified by the drive capacity specifying value D_{DRV2}.

The above-described procedure allows appropriately setting the drive capacity of the output amplifiers 42 of the source drive circuit 22 in accordance with the delay characteristics of the source lines 6.

It should be noted that the configuration illustrated in FIG. 17, which measures the delay time across the characteristic measurement source lines 6C and 6D and the bridge interconnection 8 from the digital waveform data D_{A/D}, may be used as the configuration of the drive capacity adjustment logic circuit 92, for example. The operation of adjustment of the drive capacity of the output amplifiers 42 of the source drive circuit 22 in this case is as described with reference to FIGS. 18 and 19, except for that the A/D converter 126 integrated in the touch panel controller section 112 is used.

When touch detection processing, which is a processing for detecting a contact of an object with the touch panel 103, is to be performed, on the other hand, the output of the selector 124 is connected to the input of the A/D converter 126 by the switch 125, and the output of the A/D converter 126 is connected to the input of the scan RAM 128 by the switch 127. In this case, the A/D converter 126 performs analog-digital conversion on the output signal of the X sensor 122 selected by the selector 124. The output signals of the X sensors 122 are analog signals indicating the electrical state of the touch panel 103, and this implies that the A/D converter 126 has the function of performing analog-digital conversion on the analog signals indicating the electrical state of the touch panel 103 and generating digital data indicating the electrical state of the touch panel 103. With the above-described operation, the touch panel controller section 112 obtains digital capacity information between the horizontal electrode patterns 104 and the vertical electrode patterns 105, and stores the digital capacity information in the scan RAM 128. The MPU 113 reads out the digital capacity information from the scan RAM 128, and generates touch panel detection data indicating a touch operation on the basis of the digital capacity information.

Although the A/D converter 126 is integrated in the touch panel controller section 112 in the above-described embodiment, the location of the A/D converter 126 may be variously modified in the TPC-embedded source driver IC 102. For example, the A/D converter 126 may be integrated in the source driver section 111.

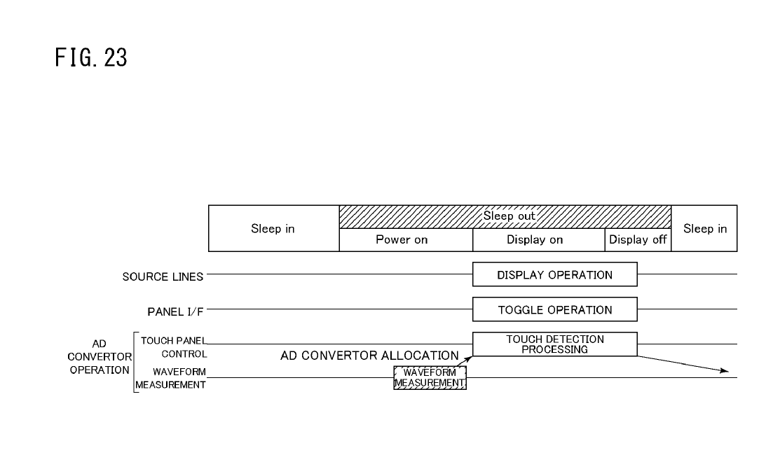

The adjustment of the drive capacity of the output amplifiers 42 of the source drive circuit 22 may be performed at various timings. For example, the adjustment of the drive capacity of the output amplifiers 42 of the source drive circuit 22 may be performed when the TPC-embedded source driver IC 102 sleeps out (i.e. when the TPC-embedded source driver IC 102 returns from the sleep state to the normal operation state) as illustrated in FIG. 23. In FIG. 23, the period during which the TPC-embedded source driver IC 102 is in the sleep state is indicated by the legend “Sleep in”, and the period during which the TPC-embedded source driver IC 102 is in the normal operation state is indicated by the legend “Sleep out”.

In this case, in one embodiment, the adjustment of the drive capacity of the output amplifiers 42 of the source drive circuit 22 may be performed in a period in which the TPC-embedded source driver IC 102 performs a power-on sequence after getting out of the sleep state (indicated by the legend “Power on” in FIG. 23). In this case, the A/D converter 126 is used to generate the digital waveform data D_{A/D} indicating the waveform of the output signal outputted from the characteristic measurement source line 6C in a specific period of the power-on sequence. The drive capacity of the output amplifiers 42 of the source drive circuit 22 is adjusted on the basis of the digital waveform data D_{A/D}. When display of an image on a liquid crystal display panel 1 is started thereafter, the A/D converter 126 is used for touch detection processing for detecting a contact of an object with the touch panel 103.

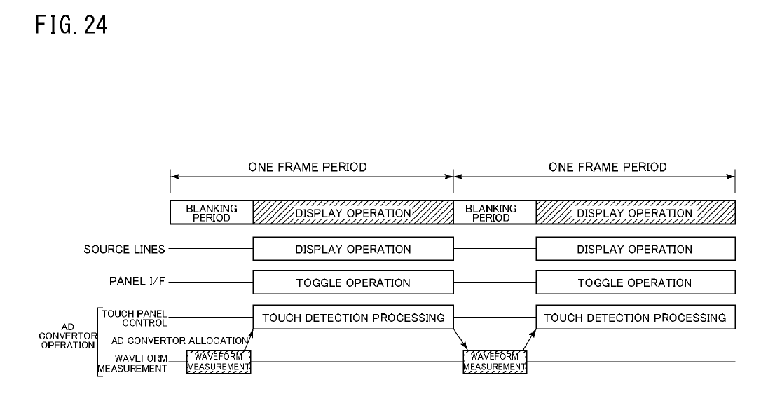

Alternatively, the adjustment of the drive capacity of the output amplifiers 42 of the source drive circuit 22 may be performed in a period when touch detection processing (processing for detecting a contact of an object with the touch panel 103) is not performed in each frame period. When touch detection processing is performed in a display period of each frame period and is not performed in a blanking period as illustrated in FIG. 24, the adjustment of the drive capacity of the output amplifiers 42 of the source drive circuit 22 may be performed in a specific period of the blanking period, for example. In this case, in the specific period, the A/D converter 126 is used to generate the digital waveform data D_{A/D} indicating the waveform of the output signal outputted from the characteristic measurement source line 6C.

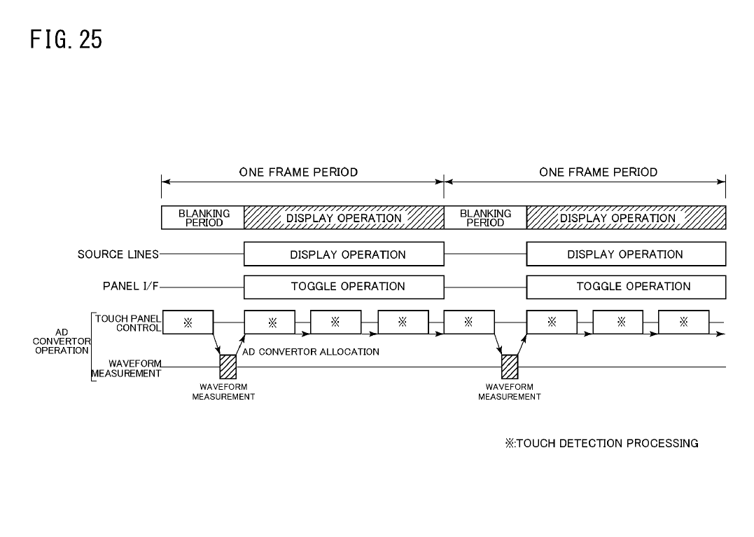

When the touch detection processing is intermittently performed in each frame period and in part of the blanking period as illustrated in FIG. 25, the adjustment of the drive capacity of the output amplifiers 42 of the source drive circuit 22 may be performed in a specific period in which the touch detection processing is not performed in the blanking period. In this case, in the specific period, the A/D converter 126 is used to generate the digital waveform data D_{A/D} indicating the waveform of the output signal outputted from the characteristic measurement source line 6C.

In the present embodiment, as described above, the A/D converter 126 is used both for the generation of digital information indicating the electrical state of the touch panel 103 and the generation of the digital waveform data D_{A/D} indicating the waveform of the output signal inputted to the measurement input pad 25 from the characteristic measurement source line 6C, thereby providing multi-functionality for the TPC-embedded source driver IC 102 with a decreased circuit size.

Although the embodiments of the present invention are specifically described in the above, the present invention should not be construed as being limited to the above-described embodiments. It would be apparent to a person skilled in the art that the present invention may be implemented with various modifications. Although the liquid crystal display device having a liquid crystal display panel is described in the above embodiments, a person having ordinary skill in the art would appreciate that the present invention is also applicable to a display device incorporating a different display panel (e.g. an OLED (organic light emitting diode) display panel and a plasma display panel), for example.

What is claimed is:

1. A display device, comprising:
a display panel; and
a driver,
wherein the display panel includes:
first to third interconnections extended in a first direction, each having a first end connected to the driver;
a plurality of first subpixels connected to the first interconnection and used for image display;
a plurality of second subpixels connected to the second and third interconnections and not used for image display; and
a bridge interconnection connecting the second and third interconnections at a second end of each of the second and third interconnections or in a vicinity of the second end of each of the second and third interconnections, the second end being located away from the driver,
wherein the driver includes:
a first drive circuit configured to drive the first interconnection;
a second drive circuit configured to drive the first end of the second interconnection; and
a drive capacity control section configured to receive a first output signal from the first end of the third interconnection and control a drive capacity of the first drive circuit in response to a waveform of the first output signal.

2. The display device according to claim 1, wherein the drive capacity control section is configured to control the drive capacity of the first drive circuit in response to a delay time across the second and third interconnections and the bridge interconnection.

3. The display device according to claim 2, wherein the second drive circuit is configured to drive the first end of the second interconnection in response to an assertion of a control signal;
wherein the drive capacity control section includes:
a comparator configured to compare a voltage level of the first output signal with a threshold level;
a counter configured to start a counting operation in response to the assertion of the control signal and configured to the counting operation in response to a second output signal outputted from the comparator; and
a control logic circuit configured to control the drive capacity of the first drive circuit in response to a count value held by the counter at a moment when the counting operation is stopped.

4. The display device according to claim 2, wherein the second drive circuit configured to drive the first end of the second interconnection in response to an assertion of a control signal;
wherein the drive capacity control section includes:
an A/D converter configured to perform an analog-digital conversion on the first output signal to generate digital waveform data;
a delay section configured to delay the digital waveform data and configured to output the delayed digital waveform data;
a comparator circuit configured to compare the digital waveform data received from the A/D converter with the digital waveform data received from the delay section;
a counter configured to start a counting operation in response to the assertion of the control signal and configured to stop the counting operation in response to a second output signal outputted from the comparator circuit; and
a control logic circuit configured to control the drive capacity of the first drive circuit in response to a count value held by the counter at a moment when the counting operation is stopped.

5. The display device according to claim 1, wherein the drive capacity control section includes:
an A/D converter configured to perform an analog-digital conversion on the first output signal to generate digital waveform data indicating a voltage level of the first output signal at each time; and
a control logic circuit configured to control the drive capacity of the first drive circuit in response to the digital waveform data.

6. The display device according to claim 5, further comprising a touch panel,
wherein the A/D converter is operable to perform an analog-digital conversion on an analog signal indicating the electrical state of the touch panel to generate digital data indicating the electrical state of the touch panel.

7. The display device according to claim 3, wherein the first and second drive circuit has the same configuration, and
wherein the drive capacity control section configured to determine whether a drive capacity of the second drive circuit is appropriate by comparing the count value held by the counter at the moment when the counting operation is stopped with a reference value, and, when determining that the drive capacity of the second drive circuit is appropriate, set the drive capacity of the first drive circuit on a basis of the drive capacity of the second drive circuit.

8. The display device according to claim 4, wherein the first and second drive circuit has the same configuration, and
wherein the drive capacity control section configured to determine whether a drive capacity of the second drive circuit is appropriate by comparing the count value held by the counter at the moment when the counting operation is stopped with a reference value, and, when determining that the drive capacity of the second drive circuit is appropriate, set the drive capacity of the first drive circuit on a basis of the drive capacity of the second drive circuit.

9. The display device according to claim 1, wherein the display panel further includes:
first and second dummy interconnections extended in the first direction; and
a plurality of third subpixels connected to the first and second dummy interconnections and not used for image display,
wherein the first, second, third interconnections and the first and second dummy interconnections are arrayed in a second direction perpendicular to the first direction, and
wherein the first, second and third interconnections are disposed between the first and second dummy interconnections.

10. The display device according to claim 9, wherein the second and the third interconnections are disposed adjacent to the first dummy interconnection.

11. The display device according to claim 1, wherein the display panel includes a liquid crystal display panel, and
wherein the first interconnection includes a source line.

12. The display device according to claim 1, wherein the display panel includes a liquid crystal display panel, and
wherein the first interconnection includes a gate line.

13. A display panel driver for driving a display panel including:
first to third interconnections extended in a first direction;
a plurality of first subpixels connected to the first interconnection and used for image display;
a plurality of second subpixels connected to the second and third interconnections and not used for image display; and
a bridge interconnection connecting the second and third interconnections at a first end of each of the second and third interconnections or in a vicinity of the first end of each of the second and third interconnections with the first end allocated away from the display panel driver, the display panel driver comprising:
a first drive circuit configured to drive the first interconnection;
a second drive circuit configured to input a step signal to a second end of the second interconnection, the second end being opposite to the first end across the second interconnection; and
a drive capacity control section configured to receive a first output signal from a third end of the third interconnection and configured to control a drive capacity of the first drive circuit in response to a waveform of the first output signal, the third end being opposite to the first end across the third interconnection.

14. The display panel driver according to claim 13, wherein the drive capacity control section is configured to control the drive capacity of the first drive circuit in response to a delay time across the second and third interconnections and the bridge interconnection.

15. The display panel driver according to claim 14, wherein the second drive circuit configured to drive the second end of the second interconnection in response to an assertion of a control signal;
wherein the drive capacity control section includes:
a comparator configured to compare a voltage level of the first output signal with a threshold level;
a counter configured to start a counting operation in response to the assertion of the control signal and configured to stop the counting operation in response to a second output signal outputted from the comparator; and
a control logic circuit configured to control the drive capacity of the first drive circuit in response to a count value held by the counter at a moment when the counting operation is stopped.

16. The display panel driver according to claim 14, wherein the second drive circuit configured to drive the second end of the second interconnection in response to an assertion of a control signal;
wherein the drive capacity control section includes:
an A/D converter configured to perform an analog-digital conversion on the first output signal to generate digital waveform data;
a delay section configured to delay the digital waveform data and configured to output the delayed digital waveform data;
a comparator circuit configured to compare the digital waveform data received from the A/D converter with the digital waveform data received from the delay section;
a counter configured to start a counting operation in response to the assertion of the control signal and configured to stop the counting operation in response to a second output signal outputted from the comparator circuit; and
a control logic circuit configured to control the drive capacity of the first drive circuit in response to a count value held by the counter at a moment when the counting operation is stopped.

17. The display panel driver according to claim 13, wherein the drive capacity control section includes:
an A/D converter configured to perform an analog-digital conversion on the first output signal to generate digital waveform data indicating a voltage level of the first output signal at each time; and
a control logic circuit configured to control the drive capacity of the first drive circuit in response to the digital waveform data.

18. The display panel driver according to claim 17, wherein the A/D converter is operable to perform an analog-digital conversion on an analog signal indicating the electrical state of a touch panel disposed adjacent to the display panel to generate digital data indicating the electrical state of the touch panel.
